(19) United States
(12) Patent Application Publication
(10) Pub. No.: US 2006/0111983 A1
(43) Pub. Date: May 25, 2006

(54) System, apparatus, and method for facilitating point-of-sale transactions

(76) Inventor: Alexander E. Malison, Silver Spring, MD (US)

Correspondence Address: PILLSBURY WINTHROP SHAW PITTMAN LLP, 1650 TYSONS BOULEVARD, MCLEAN, VA, 22102, US

(21) Appl. No.: 10/068,887

(22) Filed: Feb. 11, 2002

Related U.S. Application Data
(60) Provisional application No. 60/326,218, filed on Oct. 2, 2001.

(51) Int. Cl. G06Q 30/00

(52) U.S. Cl. 705/26

(57) ABSTRACT

A system, apparatus, and method for facilitating point-of-sale (POS) transactions, including a user interface having an input area for receiving handwritten input, a selection window for displaying items associated with the handwritten input, and an order window for displaying selected items. The apparatus can include a button to choose options and to enter commands into the user interface, and a notification device to provide non-visual feedback. The method can include steps in which a handwritten input is received from a user on a user interface of a POS computer and the handwritten input identifies the item. Then, an indication from the user can be received through the POS computer, where the indication selects the item, and finally, the item is added to the order. Another embodiment provides an abbreviation scheme that speeds data entry into the input area.

This application claims the benefit of U.S. Provisional Application No. 60/326,218, filed Oct. 2, 2001, which is herein incorporated by reference in its entirety.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field of the Invention

The present invention relates generally to wireless point-of-sale (POS) systems, and in particular, to a system, apparatus, and method for receiving orders from customers, especially customers of full service restaurants.

2. Background of the Invention

Friendly and efficient customer service is crucial to the success of any restaurant or retail store. Consumers demand fast and accurate service, but also appreciate one-on-one attention that caters to their individual needs. To encourage repeat business, restaurants and retailers must therefore personalize their services by providing representatives that closely interact with customers and satisfy the needs of those customers quickly and efficiently, in the relatively short time that customers typically spend in restaurants and retail stores.

In the full service restaurant business, the key to this personalized service is the attention that the server devotes to the customer in guiding the customer through the menu and taking the customer's order. When interacting with the customer, the server should preferably maximize eye contact with the customer, respond quickly and attentively to any questions, and record the customer's order accurately, without having to later interrupt the customer's dining experience with further questions about the order.

In a typical restaurant, when a server takes an order, the server either memorizes each selection or writes the selections on a note pad. During the interaction, the server can maintain significant eye contact with the customer, especially if the server is memorizing the order or is writing on a pad without looking down. After taking the order, the server then leaves the table, steps up to a fixed point-of-sale (POS) terminal, and enters the order into the POS terminal. Thus, the server effectively processes the order twice, first recording the order at the table and then entering the order into the POS system.

This duplicative process is not only time-consuming, but also often results in errors. For example, a server relying on memory may be interrupted on his way to the fixed POS terminal by a request from another table, and, as a result, may forget portions of the order. In another frequent situation, a server writing on a notepad may be unable to read his illegible notes at the fixed POS terminal. As another example, in entering the order into the fixed POS terminal and responding to prompts for required information, the server may realize that he forgot to ask the customer for options related to the order, such as the customer's choice of side items that accompany an entree. As another example, after taking the order, the server may return to the fixed POS terminal and find out that an item that the customer ordered has been deleted from the menu (e.g., because supplies ran out). In any of these cases, the server must return to the table and interrupt the customer's dining experience to complete the order correctly.

Recognizing the inefficiencies in receiving an order at a table and returning to a fixed POS terminal to enter the order into the restaurant POS system, some designers of POS systems have turned to wireless mobile POS devices. These devices enable servers to enter orders directly into the POS system at the customer's table, thereby eliminating the extra steps involved in returning to a fixed POS terminal and the associated errors that often occur during those steps. Thus, these wireless POS devices eliminate the need for a server to memorize or keep meticulous notes on an order. In addition, the wireless POS devices have the same ability as fixed POS terminals to prompt the server for order options (e.g., sides or how to prepare a steak) and to advise the server of deleted menu items.

Despite these advantages, the wireless POS devices that have been developed thus far have not been well received by the full service restaurant industry, due at least in part to a significant usability drawback. Specifically, these conventional wireless POS devices require that the server divert a considerable amount of attention away from the customer, to concentrate on entering data into the wireless POS device. This concentration is necessary because the conventional wireless POS devices use the same types of user interfaces found on large screened, fixed POS terminals.

FIG. 1 illustrates an example of a user interface for a fixed POS touchscreen terminal, called Tejas™, produced by CSI Software of Houston, Tex. (see www.csisoftwareusa.com). As shown, these user interfaces present multiple buttons, each of which represents a menu item or a category of items. To select an item, a user must search the entire screen for the appropriate button. If the button for a particular item does not appear on the initial screen, then the user must activate a category button and proceed down through a menu of buttons to find the button corresponding to the particular item. In fact, this menu-driven user interface is basic to the appearance and functionality of conventional foodservice POS systems, such as those produced by MICROS™ Systems, Inc. of Columbia, Md. and Aloha™ Technologies of Bedford, Tex. With fixed POS terminals, the button menu navigation is manageable because the server can devote his full attention to the interface. However, when the server is using a wireless POS device to take an order at a table, navigating through the buttons and menus of this complex interface requires the server to ignore the customer for long periods of time.

The smaller display screens of the wireless POS devices further compound this usability problem. In comparison to the typical 15-inch computer touchscreen of fixed POS terminals, wireless POS devices typically have displays roughly equivalent in size to commercially available Personal Digital Assistants (PDAs), such as Pocket PCs and Palm Pilots™. In adapting the touchscreen button interfaces of the fixed POS terminals to these smaller displays, designers of the conventional wireless POS devices have simply reduced the number of buttons presented on the screen and increased the number of menu levels (i.e., screens) through which a user must navigate. This approach requires the server to hunt, with his head down, through multiple screens and search for desired buttons, all while standing in front of the customer. These cumbersome button interfaces therefore distract the server's attention, and detract from the customer's dining experience.

As an example, FIG. 2 illustrates the conventional button interface used on the wireless POS terminal, 21 st Century Restaurant™, produced by Ameranth Technology Systems of San Diego, Calif. As shown, in comparison to the button interface of FIG. 1, the screen provides a limited number of buttons. Moreover, each button represents a category, rather than a final selection (i.e., menu item). Thus, the server must choose a category button and drill down through additional category buttons to reach a desired item button. The server must therefore learn additional layers of buttons, and tediously navigate through those layers while taking an order at a table.

Thus, the button interfaces of conventional wireless POS devices burden users with complicated menu layers. The complex menu structure lacks an intuitive ease of use and requires servers to spend substantial time and effort on learning how to use the interface. Furthermore, even after a server has mastered the menu structure, the server must still focus his full attention on the interface when entering an order. The server therefore breaks eye contact with the customer for significant stretches of time, making both the server and customer feel awkward.

### SUMMARY OF THE INVENTION

The present invention enables a server to take a customer's order at the table and to gather all of the information required for that order, all while maintaining courteous and attentive eye contact. Unlike the cumbersome button menu interfaces of the prior art, the present invention provides an intuitive user interface for entering orders, which responds to commonsensical handwritten input. A server is therefore able to enter an order naturally, using ordinary handwriting strokes to select items and commands. Moreover, after initially positioning his hand over a handwriting recognition input area, the server can enter the order without looking at the interface. Thus, the server can remain focused on the personal interaction with his customers.

In an embodiment of the present invention, the user interface includes a handwriting input area, a selection window, and an order window. The server hand writes menu items and commands into the input area, which is configured with handwriting recognition software. During this data entry, the selection window displays and continuously updates a list of possible item or command selections, which correspond to the characters entered into the input area up to that point. After completely writing the item or command in input area, the server selects the item or executes the command by entering a command stroke (e.g., a period) in the input area. Selected items are listed in the order window. The server can therefore enter a complete order, along with the necessary commands (e.g., send the order for preparation), without looking at the user interface. If necessary, however, the server can quickly look at the selection window during data entry or the order window after data entry, to confirm that the item, command, or overall order is correct.

In an alternative embodiment of the present invention, the input area of the user interface contains a keyboard or keypad with which a user can enter data, in addition to or in place of writing into the input area.

Another embodiment of the present invention provides an abbreviation scheme that speeds input. Instead of entering the full name of an item or command, the server enters an abbreviation. As the server enters each character of the abbreviation, the selection window displays and continuously updates a list of possible abbreviations beginning with the characters entered up to that point. The server can select the item or execute the command either by completely entering the abbreviation and entering a command stroke (e.g., a period) in the input area, or by touching the particular item or command listed in the selection window.

Another embodiment of the present invention provides the unique user interface described above on a POS computer, which could be a fixed or mobile computer. A further embodiment of the present invention provides a computer network for facilitating POS transactions, which includes computers running the unique user interface described above.

Another embodiment of the present invention provides a hardware button for selecting an item or executing a command. This button is provisioned on the device that is operating the user interface, such as a PDA or other similar handheld computer. To select an item or command, a server presses the button after completely entering the item or command in the input area, or after highlighting the item or command in the selection window.

Another embodiment of the present invention provides a notification device in conjunction with the user interface. This notification device provides the server with non-visual feedback (e.g., a vibration) regarding the data entry. The notification device is activated during data entry to, for example, prompt for required input or to indicate error conditions.

Another embodiment of the present invention provides a method for receiving an order of an item through a POS computer, which includes receiving a handwritten input from a user, wherein the handwritten input identifies the item; receiving an indication from the user, wherein the indication selects the item; and adding the item to the order. In another embodiment, the method further includes displaying the order on the POS computer, receiving a command to send the order for preparation, and sending the order to an output device in a preparation area.

Accordingly, an object of the present invention is to enable a server to record a customer's order in a mobile POS device while looking at the customer for a majority of the time in which the order is taken.

Another object of the present invention is to enable a server to use natural handwritten input (or keypad input) to record an order.

Another object of the present invention is to provide a server with non-visual feedback regarding an order as the order is being entered.

These and other objects, aspects, and advantages of the present invention are described in greater detail in the detailed description of the invention and the attached materials. Additional features and advantages of the invention will be set forth in the description that follows, will be apparent from the invention, or may be learned by practicing the invention.

### BRIEF DESCRIPTION OF THE DRAWINGS

FIG. 1 is a screen image of an order entry user interface on a fixed POS touchscreen terminal, known in the prior art.

FIG. 2 is a screen image of an order entry user interface on a wireless POS terminal, known in the prior art.

FIG. 3A is a schematic diagram of an exemplary POS user interface according to an embodiment of the present invention.

FIG. 3B is a schematic diagram of an exemplary POS user interface that, in comparison to the user interface of FIG. 3A, includes additional areas to receive information from the user and to display information to the user, according to an embodiment of the present invention.

FIG. 3C is a screen image of the exemplary POS user interface of FIG. 3B, with representative characters and images populating each of the areas of the interface, according to an embodiment of the present invention.

FIGS. 4A and 4B are schematic diagrams exemplary hardware configurations, according to an embodiment of the present invention.

FIG. 5 is a schematic diagram of an exemplary hardware configuration including a tether and belt pack, according to an embodiment of the present invention.

FIG. 6 is a flowchart of a method for receiving an order, according to an embodiment of the present invention.

FIGS. 7-18 are a series of screen images of an exemplary POS user interface, illustrating an exemplary method for entering an order, according to an embodiment of the present invention.

FIGS. 19-30 are a series of screen images of an exemplary POS user interface, illustrating a method for accessing a group of items and for deleting an item, according to an embodiment of the present invention.

FIG. 31 is a schematic diagram of an exemplary system architecture, according to an embodiment of the present invention.

FIG. 32 is a screen image of an exemplary POS user interface in a keyboard entry mode, with a right-handed keyboard, according to an embodiment of the present invention.

FIG. 33 is a screen image of an exemplary POS user interface in a keyboard entry mode, with a left-handed keyboard, according to an embodiment of the present invention.

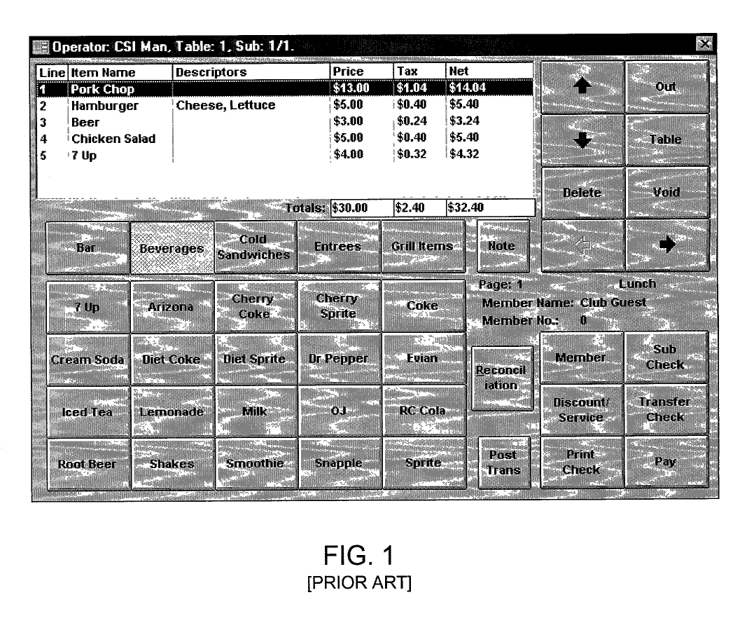

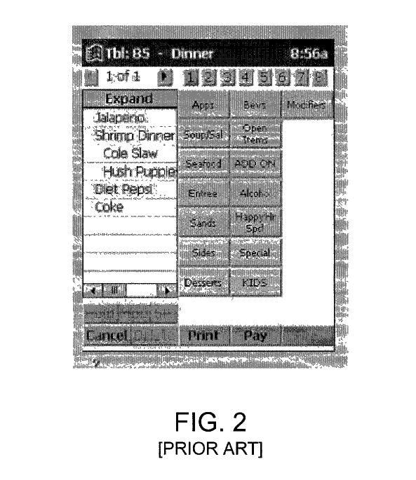

### DETAILED DESCRIPTION OF THE INVENTION

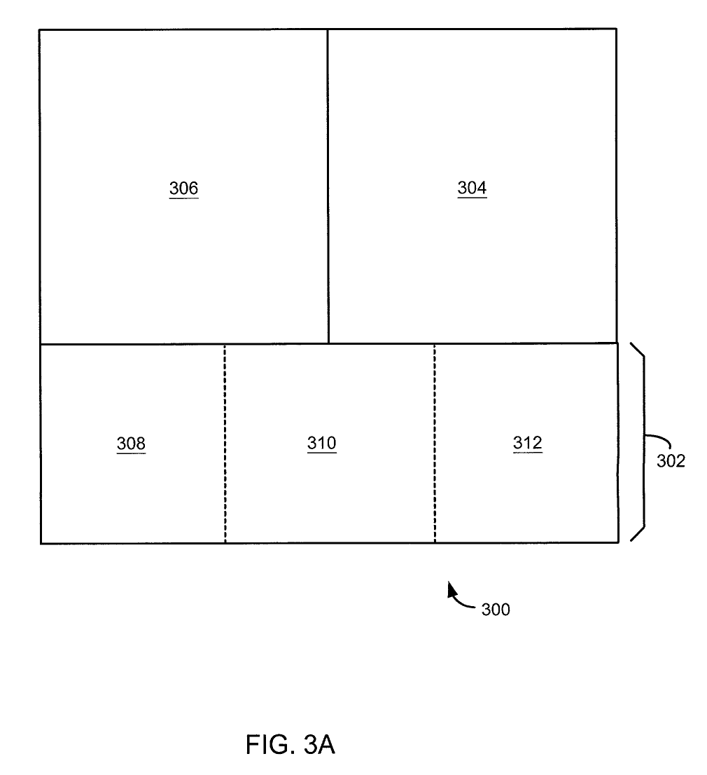

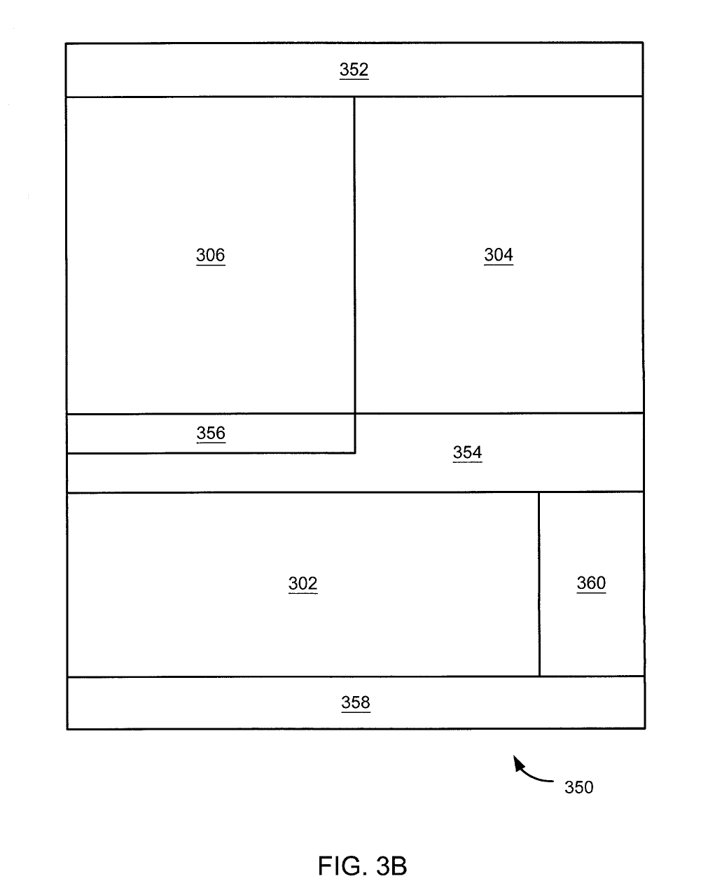

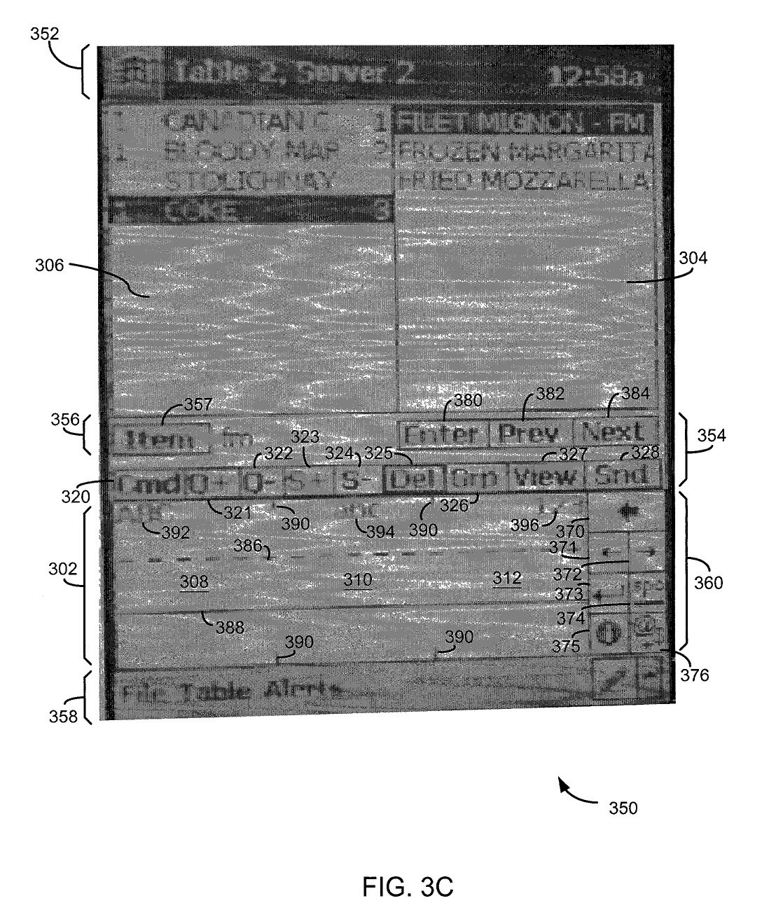

FIG. 3A illustrates a user interface 300 according to an embodiment of the present invention. Broadly defined, user interface 300 includes an input area 302, a selection window 304, and an order window 306. User interface 300 would be displayed, for example, on a PDA or handheld computer, such as the iPAQ 3600 Series Pocket PC™ (produced by Compaq of Houston, Tex.) running a Microsoft Windows CE™ operating system. Consistent with these types of devices, a user would use a stylus or other similar instrument to contact the touchscreen of the PDA or handheld computer and to interact with any portion of user interface 300.

Input area 302 receives commands, item selections, modifier selections, and numeric input from a user. Commands instruct the user interface software to execute software functions, such as opening a new table order or sending a completed table order to the kitchen for preparation. Item selections correspond to specific menu items, such as a New York strip steak or lasagna. A modifier selection is a complementary item or message that is linked to an item selection. For example, if an item selection is a New York strip steak, a modifier selection associated with that item selection could be a side dish that comes with that item, such as a baked potato or French fries. As another example, the modifier selection could be a message describing how to prepare the steak, such as rare, medium, or well done. Numeric input in input area 302 would be used any time that a number is called for, such as a table number or the number of customers at a particular table.

To receive these various entries from a user, input area 302 is preferably configured with handwriting recognition software that interprets handwritten strokes of the user. Examples of suitable handwriting recognition software include Graffiti™ produced by Palm of Santa Clara, Calif. and Transcriber™ produced by Microsoft Corporation™ of Redmond, Wash.

Selection window 304 is a multi-purpose window that changes in response to the commands, items, modifiers, and numeric input entered into input area 302. For example, if a user enters an item (e.g., a New York strip steak) in input area 302, then selection window 304 presents a list of options, or modifiers, from which a user can choose (e.g., rare, medium, or well done). Similarly, as another example, if a user enters a command (e.g., open order) in input area 302, then selection window 304 presents a list of all other command options from which the user can choose.

Selection window 304 can also provide lists of options while a user is entering an item, command, or modifier in input area 302. For example, if the user is entering a three-letter command, then after the user enters the first letter, selection window 304 can display a list of all commands that begin with that letter. The user can then either select the desired command from selection window 304 or continue writing the last two letters in input area 302 to execute the command. This abbreviation scheme is described in more detail below.

In addition to lists of options, the multi-purpose selection window 304 can also display other miscellaneous information, such as table status (e.g., open or closed) and detailed item descriptions (e.g., ingredients and recipes).

With selection window 304, the present invention limits and positionally fixes the area on which a user must focus when presented with options or miscellaneous information. This configuration therefore provides a fast, intuitive, and easy to learn method for selecting options and obtaining miscellaneous information.

Order window 306 of user interface 300 displays a running list of the items that have been selected. Thus, if the user selects a chef salad using input area 302 and selection window 304, then order window 306 lists “chef salad” as the current order. As the user selects additional items, those items are added to the order and displayed in order window 306. Optionally, order window 306 also indicates which customer of the table has ordered a particular item by listing a customer number next to the item. Thus, for example, for a table of two customers, the items ordered by the first customer would have a “1” listed next to them, while the items ordered by the second customer would have a “2”.

As shown in FIG. 3A, a further embodiment of the present invention divides input area 302 into a command input section 308, an item/modifier input section 310, and a numeric input section 312. Any portion of the input area 302 can accept any desired form of input, e.g., Graffiti™, Transcriber™, numbers, or plain text. Also, the various portions of input area 302 can receive the same or different forms of input as other portions of input area 302. Preferably, a user writes in each of these sections 308, 310, and 312 using lowercase cursive characters. Command input section 308 receives the lowercase handwritten command entries and returns corresponding uppercase characters to the user interface software. In contrast, item/modifier input section 310 receives lowercase input/modifier entries and returns those lowercase characters to the user interface software. These different case settings enable the user interface software to distinguish commands from items and modifiers.

Numeric input section 312 receives numeric characters associated with either commands or items/modifiers.

Sections 308, 310, and 312 can be shuffled and moved to assume different absolute and relative positions with each other. In addition, other portions (e.g., input area 302, selection window 304, and order window 306) and screen features of user interface 300 can be moved as well.

FIG. 3B illustrates a user interface 350 according to an alternative embodiment of the present invention. In comparison to user interface 300 (FIG. 3A), user interface 350 includes additional areas to receive information from the user and to display information to the user. As shown, these areas include a title bar 352, a speed button area 354, an entry status bar 356, a program menu bar 358, and a button menu 360.

Title bar 352 displays information associated with the order currently being processed. This information could include, for example, the current time, the number of the table at which the order is being taken, an identification of the server taking the order, the number of customers at the table, the seat number for which items are being entered, and the mode in which user interface 350 is operating (e.g., order entry mode or command mode). Title bar 352 can also display helpful hints and/or prompts relating to an item or command that is being entered. Title bar 352 can also display status messages relating to the operation of the user interface software, such as a message reading “modify item” when a forced modifier is required, or a message reading “choose command” when user interface 350 is in the command mode.

Speed button area 354 provides buttons that are programmed to execute often-used functions, such as deleting the last item entered, incrementing and decrementing seat numbers, and sending orders to preparation areas. Each button provided in speed button area 354 preferably executes one function.

Entry status bar 356 shows the characters that are entered in input area 302, as those characters are being entered. Thus, if the command for sending a completed order to the kitchen is “si”, for “send items”, then as the user enters the “s” of the “si”, the “s” is displayed, preferably in a legible font, in entry status bar 356. Similarly, for item entry, if the keystrokes required to enter a “filet mignon” are “fm”, then as the user enters the “f” of the “fm”, the “f” is displayed in entry status bar 356. Within entry status bar 356, the status of item entries and command entries can be shown in separate display fields, or can be shown in a single display field that toggles between items and commands as different items and commands are entered.

Program menu bar 358 can also display status messages like those of title bar 352. Program menu bar 358 can also provide buttons to activate other functions of the user interface software. Examples of these other functions include an open table function, a file function, and an alerts function. Touching the open table function would prompt the user to enter the number of the table for which the user would like to enter data. If the table is a new table, the user would also be prompted for the number of customers at the table.

Touching the file function would provide, for example, server login and manager functions. The server login functions allow a server to login or out to change the active server who using the handheld. The manager functions provide features such as producing reports and viewing open checks.

Touching the alerts function would, for example, provide the user with reports on a number of issues related to orders. Alerts to servers could, for example, indicate that food is ready for a table or that a table needs service. Alerts to managers could, for example, indicate that a table needs service (e.g., if time at a table exceeds a predetermined amount of time, indicating the table needs attention regarding the issuing or settlement of the check), that labor costs are exceeding some preset threshold, or that an employee overtime situation exists.

Button menu 360 provides functions for manipulating text entered through input area 302. For example, menu 360 could include a backspace delete button, a forward delete button, a forward space button, a backward space button, an enter or return button, and a space button. In this manner, if a user mistakenly enters a letter in input area 302, which is then shown in entry status bar 356, the user can use a backspace delete button of menu 360 to delete the incorrect letter and start over with the entry of the item or command. In addition to cursor function buttons, button menu 360 could also include a help or information button and a button for accessing common typographical symbols.

FIG. 3C is a preferred embodiment of user interface 350 of FIG. 3B, with representative characters and images populating each of the areas of interface 350 described above. As shown, title bar 352 displays the current time (12:58a), an identification of the table for which an order is being taken (Table 2), and an identification of the server who is taking the order (Server 2). Optionally, although not shown in FIG. 3C, title bar 352 can also display the customer for which an item or modifier is being entered.

Order window 306 displays the items that have been entered in the order thus far, which in this example includes one Canadian Club™ drink for customer 1, one Bloody Mary drink for customer 2, and one Coke™ for customer 3.

As also shown in FIG. 3C, input area 302 displays command input section 308, item/modifier input section 310, and numeric input section 312. Input area 302 includes dash line 386, solid line 388, and tick marks 390 that guide the user in writing characters within each section, by defining the boundaries of those sections. The sections also include icons 392, 394, and 396 that indicate the function of each section. For example, icon 392 (“ABC”) indicates that handwritten (lowercase) characters are returned as uppercase commands. Icon 394 (“abc”) indicates that handwritten (lowercase) characters are returned as lowercase items or modifiers. Finally, icon 396 (“123”) indicates that numeric characters are entered in section 312.

Entry status bar 356 shows that “fm” has been entered as an item in input area 302. The toggle icon 357 indicates that the characters have been entered as an item, rather than a command or modifier. Although not shown in FIG. 3C, if a command or modifier is entered in input area 302, toggle icon 357 changes to “Cmd” or “Mod”, accordingly.

Corresponding to the “fm” characters entered in input area 302 and shown in entry status bar 356, selection window 304 of FIG. 3C displays a list of items from which a user can choose. In this example, the characters “fm” correspond to the item “filet mignon”. Selection window 304 lists additional items that require additional characters beyond “fm”, which the user may want to select, but has not yet entered the additional characters. For example, the characters “fma” could correspond to the item “frozen margarita”. Likewise, the characters “fmo” could correspond to the item “fried mozzarella”. The details of this abbreviation scheme are discussed in more detail below.

As shown in the representative screen image of FIG. 3C, speed button area 354 provides buttons that are programmed to execute often-used functions, which in this example include a Cmd button 320, a Q+ button 321, a Q− button 322, a S+ button 323, a S− button 324, a Del button 325, a Grp button 326, a View button 327, a Snd button 328, an Enter button 380, a Prev button 382, and a Next button 384.

Cmd button 320 toggles entry status bar 356 from item entry mode to command entry mode, such that any characters entered into input area 302 are taken as commands. Q+ button 321 and Q− button 322 increase and decrease quantities, respectively, for a selected item. S+ button 323 and S− button 324 increase and decrease, respectively, the active seat number. Although not shown in FIG. 3C, title bar 352 can display the active seat number.

Del button 325 deletes the last item entered, or the item that is selected (highlighted) in order window 306.

Grp button 326 places the user interface in group mode so that a user can select a menu group to view.

View button 327 expands order window 306 to show the order using the entire area of user interface 350.

Snd button 328 sends an order to a preparation area.

Enter button 380 confirms a selected (highlighted) item or modifier listed in selection window 304.

Finally, Prev button 382 and Next button 384 move a highlight bar up and down the list of commands, items, or modifiers shown in selection window 304.

FIG. 3C also shows representative function buttons in button menu 360 as well as exemplary functions (File, Table, and Alerts) in program menu 358. As shown, button menu 360 includes: a backspace delete button 370 that deletes text; a forward space button 371 that moves across text without deleting; a backward space button 372 that moves across text without deleting; an enter button 373; a space button 374; a button 375 to access help or information features; and a button 376 to access special characters. Also as shown, program menu 358 provides File, Table, and Alerts functions as described above in reference to FIG. 3B.

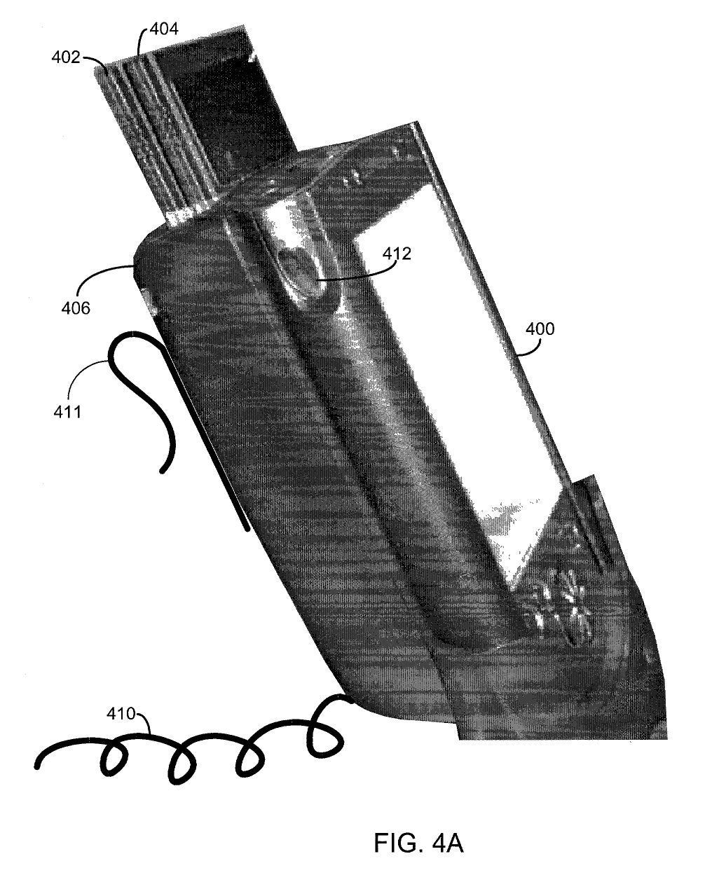

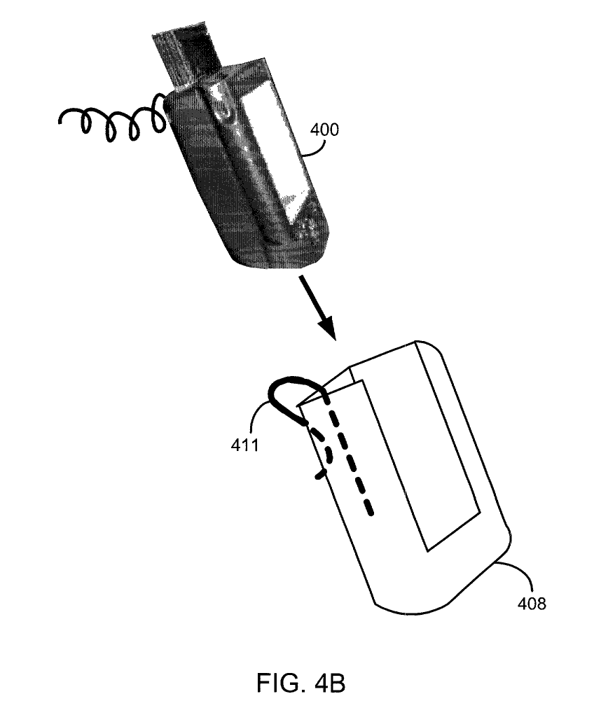

As discussed above, the user interface of the present invention (e.g., user interface 300 of FIG. 3A) is displayed, for example, on a PDA or handheld computer. FIG. 4A illustrates an exemplary hardware configuration according to an embodiment of the present invention. The embodiment shown includes a handheld computer 400 having an optional expansion card 402, an optional wireless card 404, an integrated notification device 406, and a tether 410. Although shown separately, computer 400, cards 402 and 404, and device 406 could, of course, be integrated into a single component. Optionally, as shown in FIG. 4B, the hardware configuration can also include a case, holster, or harness 408 into which computer 400 can be placed. In a further embodiment, harness 408 includes a clip 411 that can be used to attach handheld computer 400 to a belt or other apparel worn by the user, so that a user can conveniently retrieve and stow handheld computer 400, while handheld computer 400 remains attached to tether 410. Optionally, instead of using harness 408, handheld computer 400 and its attached components could be stowed in the pocket of the server or clip 411 could be attached directly to handheld computer 400.

In the exemplary configuration of FIG. 4A, handheld computer 400 is a Compaq iPAQ 3600 Series Pocket PC™ with an expansion pack. However, as one of ordinary skill in the art would appreciate, handheld computer 400 could be any computer that is capable of stylus-type data entry and wireless communication. Handheld computer 400 preferably is also ruggedized to withstand restaurant and retail environments, and includes sufficient battery life (e.g., provided in computer 400, in the expansion pack, or by an added thin profile battery pack) to sustain satisfactory operation throughout a typical work shift (e.g., 6 to 8 hours).

Preferably, as shown in FIG. 4A, handheld computer 400 has a confirm button 412. In an embodiment of the present invention, confirm button 412 serves at least two special functions. First, confirm button 412 is used to confirm item, modifier, and command entries, in a manner similar to the way in which an “Enter” key is used on a conventional computer keyboard. Thus, for example, when an item, modifier, or command is highlighted in selection window 304 (FIG. 3A), a momentary press of confirm button 412 selects that highlighted item, modifier, or command.

As a second special function, confirm button 412 can be used to place user interface 300 (FIG. 3A) in a command entry mode. In this case, rather than a momentary press, the user would press and hold down confirm button 412. Once in this mode, any characters that the user enters anywhere into input area 302 (FIG. 3A) are interpreted as a command. The command is then executed when the user releases confirm button 412. With this command entry mode feature, input area 302 of user interface 350 does not necessarily have to be separated into distinct command entry and item/modifier entry sections (e.g., sections 308 and 310 of FIG. 3A).

Confirm button 412 minimizes the time that a server is required to look at the screen of handheld computer 400, thereby increasing the time available to maintain eye contact with the customers.

Expansion card 402 and wireless card 404 provide handheld computer 400 with wireless communication. Expansion card 402 could be, for example, a PCMCIA card or a Flash Card. Examples of suitable wireless cards include a Socket Low Power WLAN card (for use with a Flash Card expansion pack) and a model number SMC2632W wireless network PC card, produced by SMC Networks, Inc. of Irvine, Calif. (for use with a PCMCIA expansion pack).

Wireless card 404 is in wireless communication with a wireless access point, which is in turn in communication with a computer network, such as a local area network (LAN). An example of a suitable wireless access point is the model number SMC2655W access point, produced by SMC Networks, Inc. of Irvine, Calif. The wireless access point is preferably in communication with a Web server of the computer network. The Web server and handheld computer 400 are provisioned with cooperative software that enables communication between the devices, and matches the data entry fields of the handheld computer software with the data entry fields of the software of the Web server. In an exemplary embodiment, the Web server and the rest of the computer network run Restaurant Manager™ software produced by Action Systems Inc. of Silver Spring, Md. The Web server (also referred to as a mobile POS server) and the computer network are described in more detail below.

Integrated notification device 406 can provide the user with a non-visual notification of the occurrence of predefined conditions. Integrated notification device 406 could be attached to or inside any of the components of FIG. 4A, but is preferably integral to the expansion pack of handheld computer 400 as shown. In providing this non-visual feedback, integrated notification device 406 could be, for example, a vibrating motor or a speaker that provides audible beeps, rings, tones, or other sounds. Preferably, however, so as not to disturb restaurant customers, integrated notification device 406 is an inaudible vibrator.

Integrated notification device 406 can be used to alert a user to an error or other condition that requires the user to look at the screen of handheld computer 400. Optionally, integrated notification device 406 has the ability to activate notifications of varying durations, each variation of which would indicate a different predefined condition. For example, using a vibrator as integrated notification device 406, a short period of vibration could indicate that the user must select an option on the screen, while a longer vibration could indicate an error condition.

Clip 411 and tether 410 attach the handheld computer 400 and its components to the user. Clip 411 (whether attached directly to handheld computer 400 or to harness 408 used in conjunction with handheld computer 400) releasably attaches handheld computer 400 to a belt or other apparel worn by the user, so that the user can conveniently retrieve and stow handheld computer 400. Tether 410 provides a more permanent attachment of handheld computer 400 to the user, which remains connected to the user when the user releases harness clip 408 and retrieves handheld computer 400 for use. Tether 410 is, for example, secured to a belt loop or dress loop. Tether 410 is preferably short enough such that it acts as a safety cord that prevents handheld computer 400 from hitting the floor if handheld computer 400 is accidentally dropped. Tether 410 also minimizes the potential of theft due, for example, to inadvertently leaving the handheld in a common area of a restaurant or retail store.

In an alternative embodiment, tether 410 is a retractable tether. For example, tether 410 could be a retractable reel, such as the retractable badge reels produced by Al Lanyards ID Badge Supply, Inc. of Baldwin, Calif. or J.A.M. Plastics, Inc. of Anaheim, Calif. In this manner, tether 410 would not be obtrusive while a server is performing the physical activities involved in serving a table (e.g., placing and clearing dishes). In a further embodiment, tether 410 is partially retractable such that a certain length of tether 410 extends from the canister reel without being pulled. The non-retracting length would depend on the distance between the point at which the tether canister is attached to the server and the point at which the server stows handheld computer 400. For example, a typical non-retracting length might be 8-12 inches. In comparison to a fully retracting tether 410, this non-retracting length would avoid a constant, and possibly uncomfortable, pull of handheld computer 400 across the server's body.

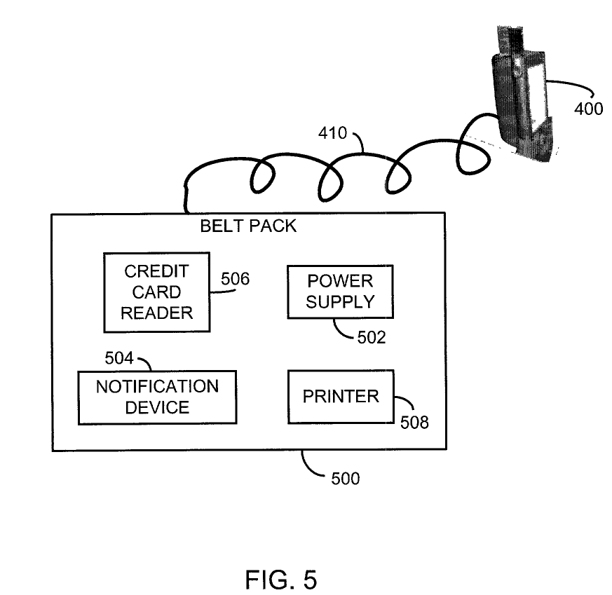

In a further embodiment of the present invention, tether 410 also provides a link to a belt pack 500, as shown in FIG. 5. This belt pack 500 includes one or more of the following components: a power supply 502, a notification device 504, a credit card reader 506, and a printer 508. In this embodiment, tether 410 includes the power and communication cables necessary to permit communication between handheld computer 400 and the components of belt pack 500, and to deliver power from belt pack 500 to handheld computer 400.

Power supply 502 can replace or supplement the power supply that is integral or attached directly to handheld computer 400. Power supply 502 therefore can extend the operational life of handheld computer 400, and can eliminate the need to have a heavy battery in handheld computer 400. An embodiment of the present invention incorporating power supply 502 therefore can reduce the weight of handheld computer 400 for easier handling by the user.

Notification device 504 in belt pack 500 functions in the same manner as the integrated notification device 406 described above, providing a non-visual notification of the occurrence of predefined conditions. Belt pack notification device 504 could be provided in place of or in addition to integrated notification device 406. Providing belt pack notification device 406 in place of integrated vibration device 406 reduces the weight of handheld computer 400, again easing the user's handling of the unit.

Credit card reader 506 (e.g., a magnetic strip reader) and printer 508 in belt pack 500 enable a server to completely process and close out an order using handheld computer 400.

In another embodiment of the present invention, rather than in belt pack 500, credit card reader 506 and printer 508 are contained in or attached to handheld computer 400.

Another embodiment of the present invention provides security features that minimize the chance that a user accidentally leaves the restaurant with the apparatus of FIGS. 4A, 4B, or 5. Specifically, thin security tags are attached to, for example, handheld computer 400, tether 410, and/or belt pack 500. Any of the well-known commercially available security tags can serve this purpose, such as those commonly used in retail environments. Tag sensors would be positioned at the entrances and exits of the restaurant, preferably located inconspicuously within the doorframes.

Preferably, in conjunction with the unique user interface and hardware described above, an embodiment of the present invention provides a novel abbreviation scheme for entering commands, items, and modifiers into handheld computer 400 (FIG. 4A) through user interface 300 (FIG. 3A). Specifically, input area 302 (see FIG. 3A) is adapted to accept abbreviations for commands, items, and modifiers. Each abbreviation is a unique sequence of letters corresponding to the particular command, item, or modifier. As an example, an abbreviation could be the first letter of the name of the command, item, or modifier, the first few letters of the name, or, in the case of a name with multiple words, the first letter of each word of the name. The manner by which each abbreviation is designated is not crucial, so long as each abbreviation is unique. Preferably, however, the abbreviations should follow common sense, so that a user can easily memorize them.

The following exemplary algorithm can be used to automatically generate unique and intuitive abbreviations for the name of a command, item, or modifier. For one-word names, the abbreviation includes, in order, as many of the letters of the name as necessary for the abbreviation to be unique. Thus, for example, if abbreviations are needed for the two items “salad” and “shrimp”, the first-entered item “salad” would be designated as “s” and the second-entered item “shrimp” would be designated as “sh”.

For multiple-word names, the abbreviation includes, in order, the first letter of each word to the extent that each letter is needed to make the abbreviation unique. If, after including the first letter of all of the words of the name, the abbreviation is not unique, then the letters succeeding the first letter of the final word are added to the abbreviation until the abbreviation is unique. Thus, for example, if abbreviations are needed for two items “frozen margarita” and “fried mozzarella”, the first-entered item “frozen margarita” would be designated as “fm” and the second-entered item “fried mozzarella” would be designated as “fmo”.

As another exemplary abbreviation scheme, command abbreviations can use single letters along with symbols that relate to the particular command. Table 1 below lists possible command abbreviations.

TABLE 1
Command Abbreviations

| Description | Abbreviation |
|---|---|
| Absolute Seat number | S<Seat #> |
| Increment Seat number | + |
| Decrement Seat number | − |
| Delete Selected Item | D |
| Absolute Quantity | Q<#> |
| Increment Quantity | Q+ |
| Decrement Quantity | Q− |
| Send Items to Prep Areas | S |
| Modifier Mode | M |

Using abbreviations, a server can enter items, modifiers, and commands into input area 302 without looking at user interface 300. After entering an abbreviation, the user momentarily presses confirm button 412 (FIG. 4A) to select the item or modifier, or execute the command. The abbreviation scheme therefore minimizes the amount of time that the server must look away from his customers. For instance, a server can enter an order for a London Broil, well done, with a salad and French fries, using the following series of abbreviations: “lb wd s ff”. (The server would press confirm button 412 after each abbreviation.)

In another embodiment of the abbreviation scheme, selection window 304 provides a dynamic word-complete list as a user enters characters into input area 302. The word-complete list includes all abbreviations that match the characters that have been entered into input area 302. Selection window 304 continually updates the word-complete list as each new character is entered, narrowing the group of possible selections.

Thus, for example, if a user writes the letter “c” in input area 302, selection window 304 might display the following list of abbreviations: c—coffee; cc—Coca Cola™; and cca—chocolate cake. The entry “c—coffee” in this list would be highlighted at this point, to indicate that the abbreviation for this item has been fully entered, and that pressing confirm button 412 will select it. If the user does not press confirm button 412, and instead goes on to write another letter “c” in input area 302, selection window 304 would update the list to show the “cc” and “cca” as the only remaining possibilities, with the entry “cc—Coca Cola™” highlighted. If the user continues by writing an “a” in input area 302, then selection window 304 again updates the list to show “cca” as the only remaining possibility, with that entry “cca—chocolate cake” highlighted. If the user then presses confirm button 412, then that item is selected and added to the order.

Alternatively, instead of pressing confirm button 412 after an abbreviation is completely entered, a user can touch the entry that is highlighted in selection window 304 for that abbreviation. As another alternative, after completely entering an abbreviation, a user can enter a handwritten command (e.g., a period) in input area 302 to select the item.

The dynamic word-complete list of this embodiment therefore enables a user to find an abbreviation when the user can only remember the first letter or first few letters of an abbreviation. Rather than hunting through a list of all commands, items, or modifiers, the user can write the first letter of the command in input area 302 and quickly browse selection window 304 to find the desired command. The more letters the user can remember in the abbreviation, the smaller the list is in selection window 304. Ideally, to maintain constant eye contact with a customer, a server would write complete abbreviations with the stylus and add the items to the order with confirm button 412. However, writing partial abbreviations and selecting from a narrowed group of possible items in selection window 304 also helps to speed up the data entry process and maximize eye contact with customers.

In another embodiment of the present invention, the abbreviation scheme makes order entry more efficient by assigning shorter abbreviations to the most often used commands, items, and modifiers. The determination of most often used commands, items, and modifiers can be based, for example, on a frequency factor (e.g., 1 to 10) computed using historical command and item sales data.

In another embodiment of the present invention, the abbreviations for items and modifiers are handled differently, such that the same abbreviations can be used for both. For example, the abbreviation “w” could be applied to both “whiskey” (item) and “well done” (modifier).

Of course, the word-complete feature of the present invention could operate apart from the abbreviation scheme. Specifically, if abbreviations are not used, and full words are entered into input area 302, selection window 304 can list all words (as opposed to abbreviations) that match the characters that have been entered into input area 302.

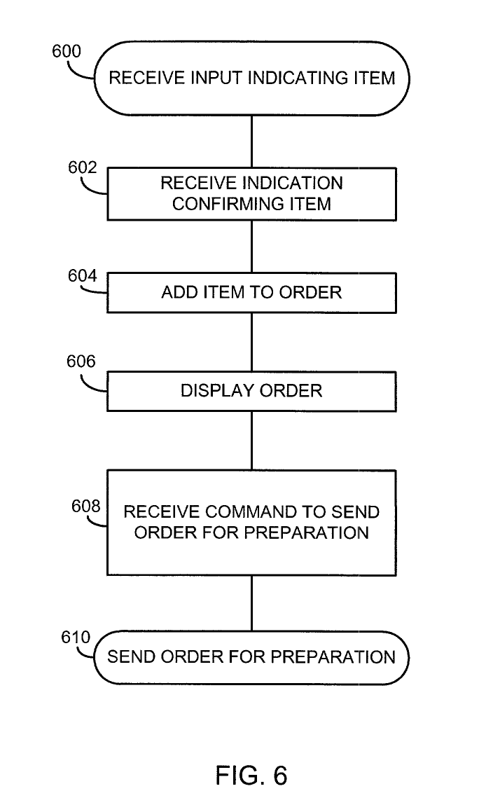

In light of the above-described user interface and hardware, FIG. 6 outlines a method for receiving an order through the POS device of the present invention, according to an embodiment of the present invention. In this simple example, the order consists of a single item (e.g., a cup of coffee).

As shown in the flowchart of FIG. 6, in step 600, the method begins by receiving handwritten input indicating the item. The user (or server, in the example of a restaurant) hand writes this input in input area 302 (FIG. 3A). User interface 300 (FIG. 3A) could be adapted to recognize the entire hand written word “coffee”. In an embodiment of the present invention, however, user interface 300 recognizes an abbreviation corresponding to the item, such as the letter “c” for the item “coffee”. Optionally, as part of step 600, user interface 300 displays the item in selection window 304.

After receiving input indicating the item, handheld computer 400 receives an indication confirming the selection of the item in step 602. The user could hand write this confirming indication in input area 302, for example, by writing a period (i.e., tapping input area 302 with a stylus) or by hand writing an “e” for enter. In another embodiment of the present invention, the user could simply press a button on handheld computer 400, such as confirm button 412 (see FIG. 4A).

With the item confirmed, in step 604, handheld computer 400 adds the item to the order. In step 606, user interface 300 displays the item in order window 306. Thus, in this example, order window 306 would read “coffee”.

At this point, the method could return to step 600 to receive additional items for the order in the same manner as the first item. However, for this simplified example of a single-item order, the method continues to step 608.

In step 608, handheld computer 400 receives a command to send the order for preparation. This command could be a single action, such as a double-click of confirm button 412. Alternatively, this command could be two successive actions, such as handwriting in input area 302 a command (as, for example, a full word “send” or an abbreviation “s”), and then pressing confirm button 412.

Finally, in response to the send command, in step 610, handheld computer 400 wirelessly communicates with a remote computer and sends the order to that computer. In this example, the order would include the item “coffee”.

An important aspect of the method of FIG. 6 is that it does not require a user to look at user interface 300 throughout the entire process of entering the items in an order, and sending the order. After initially positioning the stylus over input area 302, a user can simply hand write items into input area 302, confirming each entry with a stroke of the stylus (e.g., a handwritten period or tap) or by pressing confirm button 412. With all of the items entered, the user, still without looking at user interface, can send the order for preparation by, for example, hand writing a send command into input area 302 and pressing confirm button 412, or double-clicking confirm button 412. Entering the order in this manner therefore enables a server to keep his eyes up, with his attention devoted to the customer.

Although blind data entry is optimal, some users may wish to periodically look at user interface 300 during data entry to, among other things, confirm the accuracy of the order or other details about the operation of user interface 300. The method and apparatus of the present invention can accommodate such operation. For example, in step 602 of FIG. 6, instead of confirming an item selection with confirm button 412, a user could confirm the selection by touching an entry for the item listed in selection window 304. As another option, the user could select an “enter” button (e.g., button 380 of FIG. 3C) shown in speed button area 354 to confirm the selection of the (highlighted) item.

Similarly, in step 608, to enter a command to send the order for preparation, instead of double-clicking confirm button 412, the user could touch a “send” button shown in speed button area 354. As another option, instead of hand writing a command in input area 302 and pressing confirm button 412, the user could hand write the command in input area 302 and then touch the highlighted command listed in selection window 304.

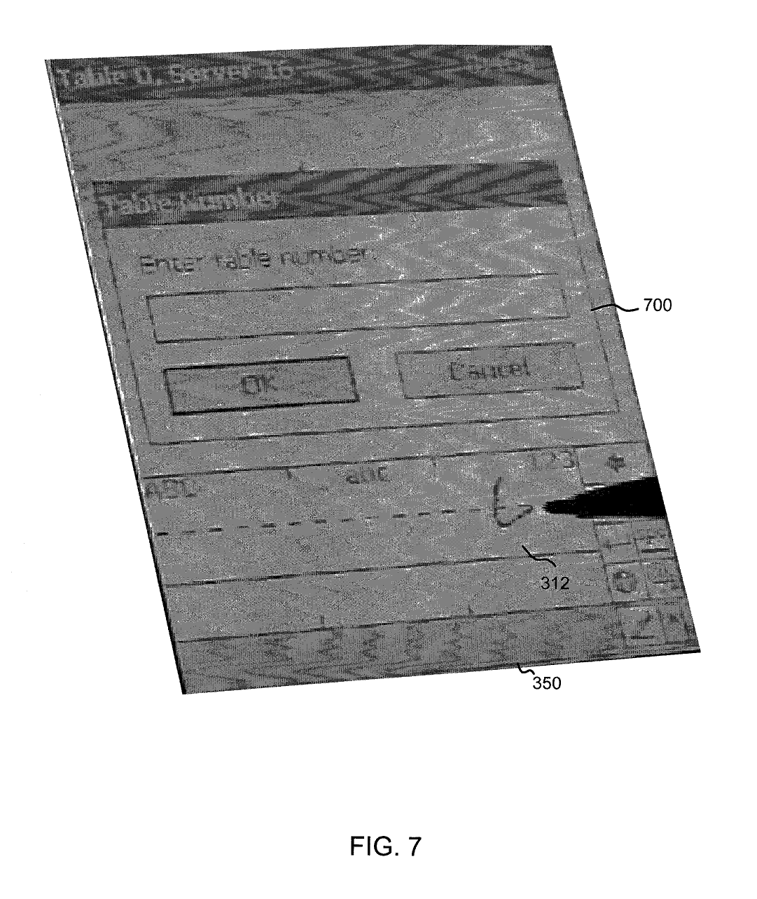

According to a further embodiment of the present invention, FIGS. 7-18 illustrate a more extensive exemplary order in comparison to that of FIG. 6. For this hypothetical example, two customers are seated at table #4, ready to order cocktails, appetizers, and main courses. The identification of the server receiving the order is server #16. Although, for illustration purposes, the following example takes the entire order of a table at once (including desserts and coffee), in a typical situation, a server would take an order in two or three visits to a table.

To open an order, a server first activates an open table function, such as a table function shown in program menu bar 358 of FIG. 3C. In response, handheld computer 400 displays on user interface 350 a data field 700 for entering a table number, as shown in FIG. 7. To enter the table number for this example, i.e., table #4, the server writes the number four (or the stroke(s) corresponding to the number four according to the handheld computer's handwriting recognition software) in numeric input area 312 of user interface 350, as shown.

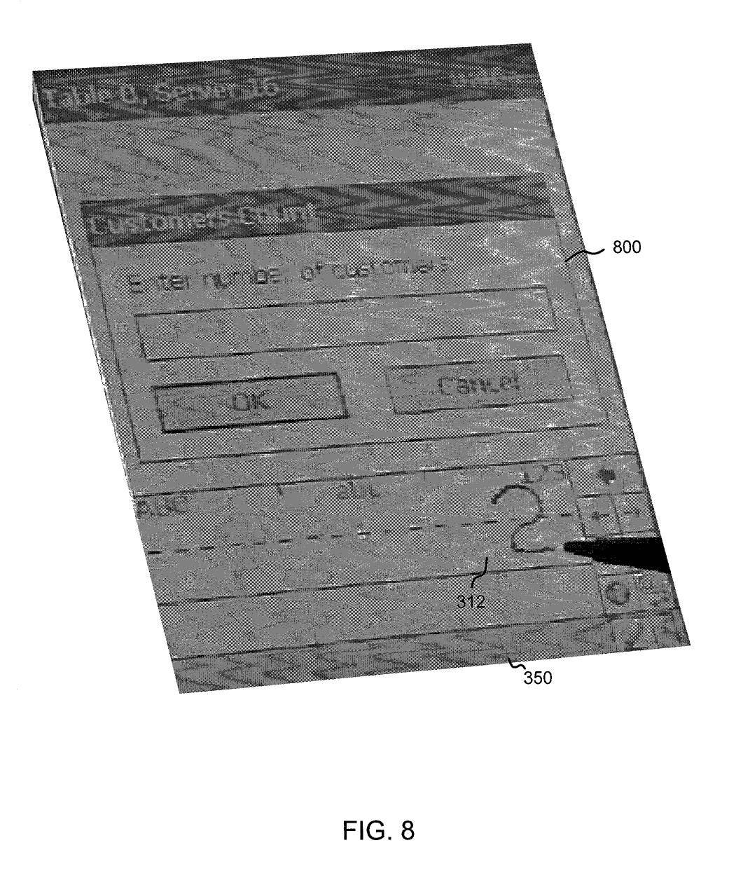

As shown in FIG. 8, handheld computer 400 then displays on user interface 350 a data field 800 for entering the number of customers at the table, which in this example is two. To enter the customer count, the server writes the number two (or the stroke(s) required by the handwriting recognition software) in numeric input area 312 of user interface 350, as shown in FIG. 8.

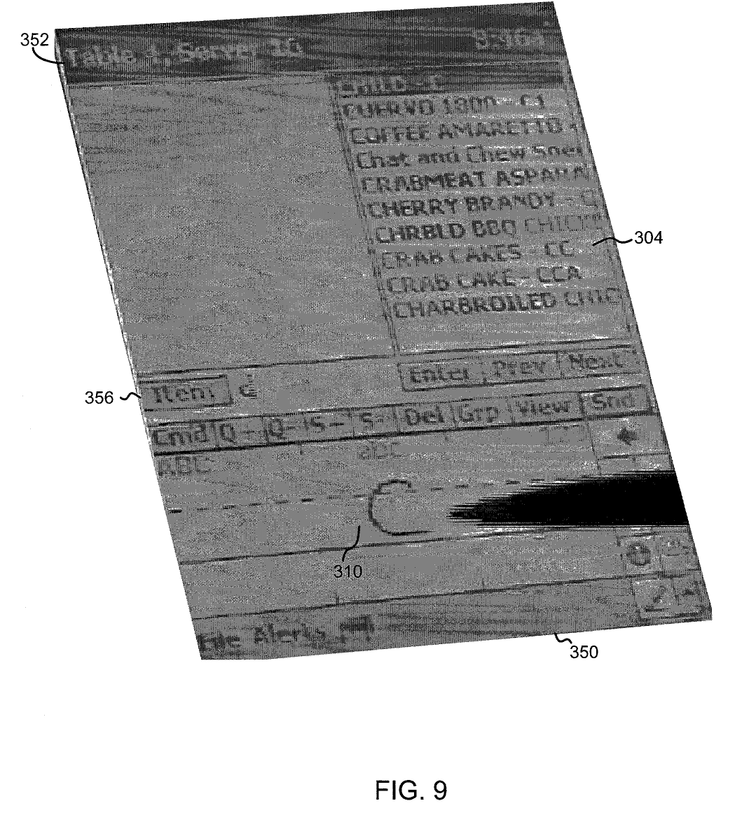

In response, handheld computer 400 updates title bar 352 of user interface 350 to display the table number (table 4) and the identification of the server (server #16), as shown in FIG. 9. User interface 350 is then ready to receive data entry.

In this example, the first customer of table #4 requests a Canadian Club™ drink. According to the abbreviation scheme of this example, the abbreviation for the drink is “ccl”. Accordingly, as shown in FIG. 9, the server enters a “c” into item/modifier input section 310.

In response to this first “c”, handheld computer 400 displays the entered character in entry status bar 356. Handheld computer 400 also displays, in selection window 304, a list of items having an abbreviation beginning with the letter “c”. This list in selection window 304 is the word-complete feature described above. Although, because of space limitations, FIG. 9 does not show a Canadian Club™ entry in selection window 304, it does appear lower in the list and could be viewed by scrolling through the list.

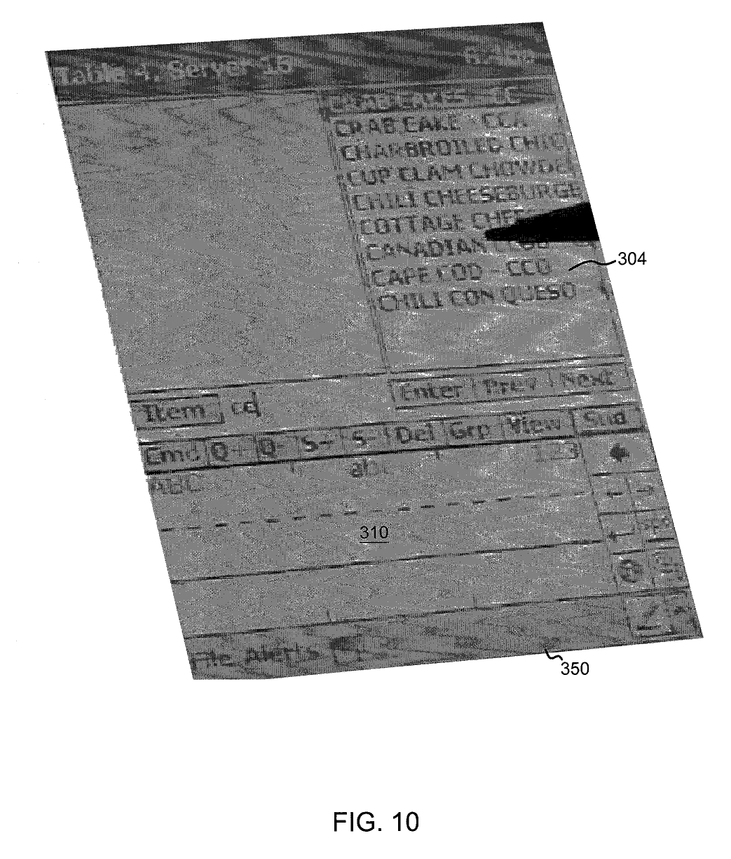

The server then proceeds to enter a second “c” in item/modifier input section 310. In response, handheld computer 400 updates entry status bar 356 to show a “cc”, as shown in FIG. 10. Handheld computer 400 also updates the list of remaining possible items and their abbreviations in selection window 304.

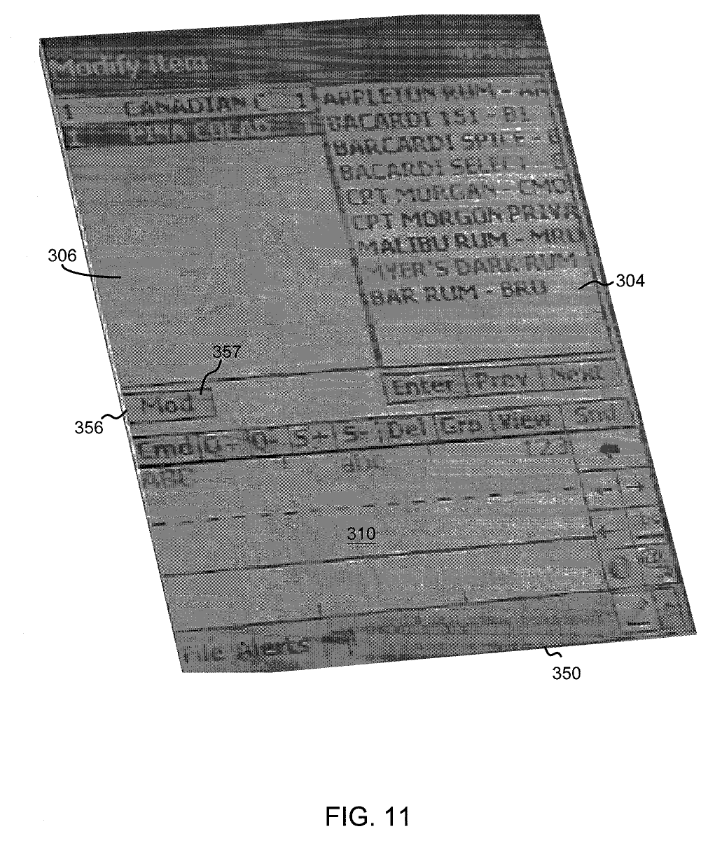

As shown in FIG. 10, the server selects the Canadian Club™ item by touching the corresponding entry in the list of selection window 304. Alternatively, as described above, to select the item, the server could also finish writing the abbreviation in item/modifier input section 310 (i.e., writing the letter “l”) and press confirm button 412. As another embodiment, handheld computer 400 could be configured such that touching Canadian Club™ entry in FIG. 10 only highlighted the item (rather than selecting it), such that the server would then select the highlighted item by pressing confirm button 412. Having received the confirmed selection of the Canadian Club™ drink, handheld computer 400 displays the item in order window 306, as shown in FIG. 11.

FIG. 11 also shows a pina colada drink added to order window 306. Although not shown in the figures, the server added this item by writing a “pc” in item/modifier input section 310.

As an additional embodiment of the present invention, FIG. 11 illustrates the occurrence of a forced modifier prompt. A forced modifier prompt occurs when a selected item has options associated with it, from which a server must choose to complete the selection of the item. For example, if an item is a steak, then a forced modifier prompt might require the server to choose whether the steak should be prepared rare, medium, or well done. The prompt would require the server's choice before the server could continue with other item entries. In the example of FIG. 11, handheld computer 400 has activated a forced modifier prompt in response to the pina colada selection, which requires the selection of a type of rum. The “Mod” shown in toggle icon 357 of entry status bar 356 indicates this prompt condition. Selection window 304 provides a list of forced modifiers (i.e., rums) from which to choose. The server can select the type of rum using any of the methods described above in selecting an item (e.g., write the abbreviation for the type of rum and press confirm button 412 or touch the name of the rum in selection window 304).

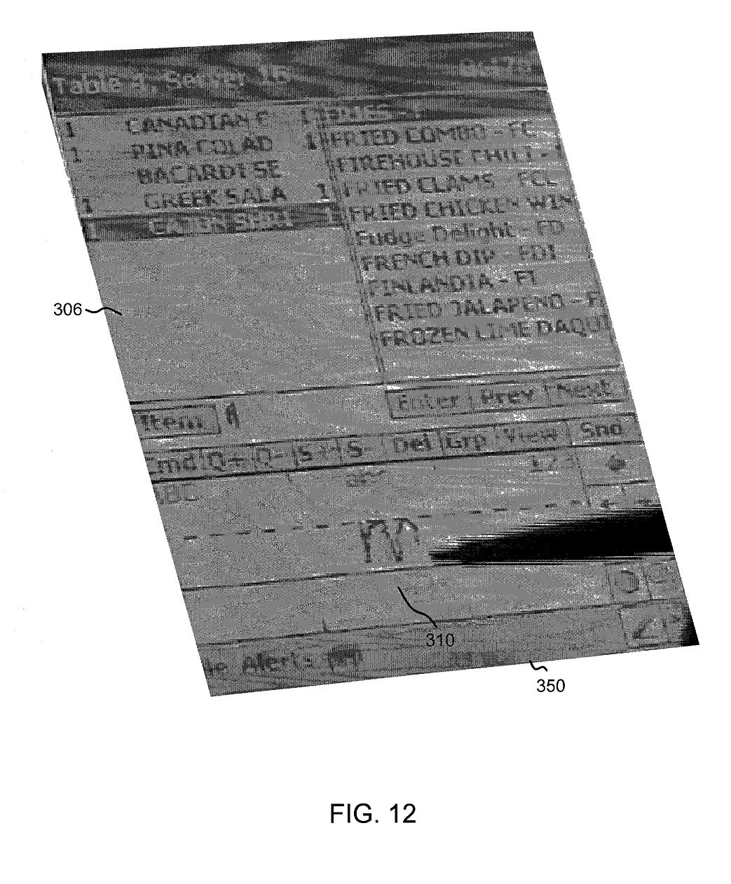

After the server selects the forced modifier, handheld computer 400 adds the item to the order in order window 306. As shown in FIG. 12, the server selected the pina colada drink prepared with Bacardi Select™ rum.

FIG. 12 also shows two more items added to the order in order window 306. The server added the Greek salad by, for example, writing a “gs” in item/modifier input section 310. The server added the Cajun shrimp by, for example, writing a “cs” in item/modifier input section 310.

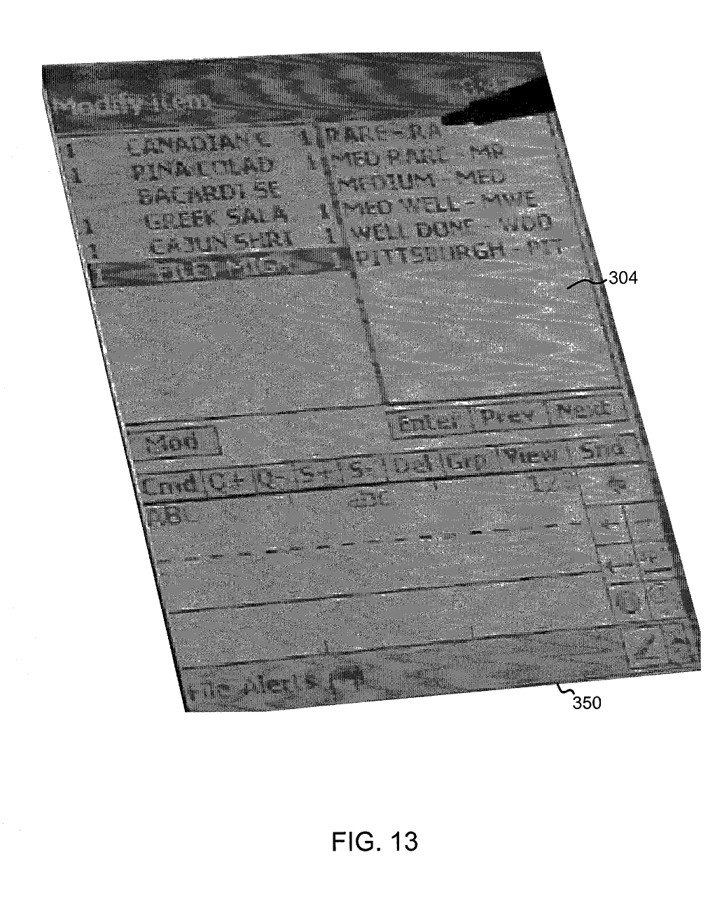

FIG. 12 also shows the server entering the abbreviation “fm” for a filet mignon. In response to the item selection, handheld computer 400 prompts the server for a forced modifier related to the item, as shown in FIG. 13. The server must select from a choice of preparation instructions for the filet mignon, which include rare, medium rare, medium, medium well, well done, and Pittsburgh, as shown in selection window 304. The server can select the appropriate preparation instructions using any of the methods described above in selecting an item or modifier. In this particular example, the server simply touches the entry for a rare filet mignon, as shown in FIG. 13.

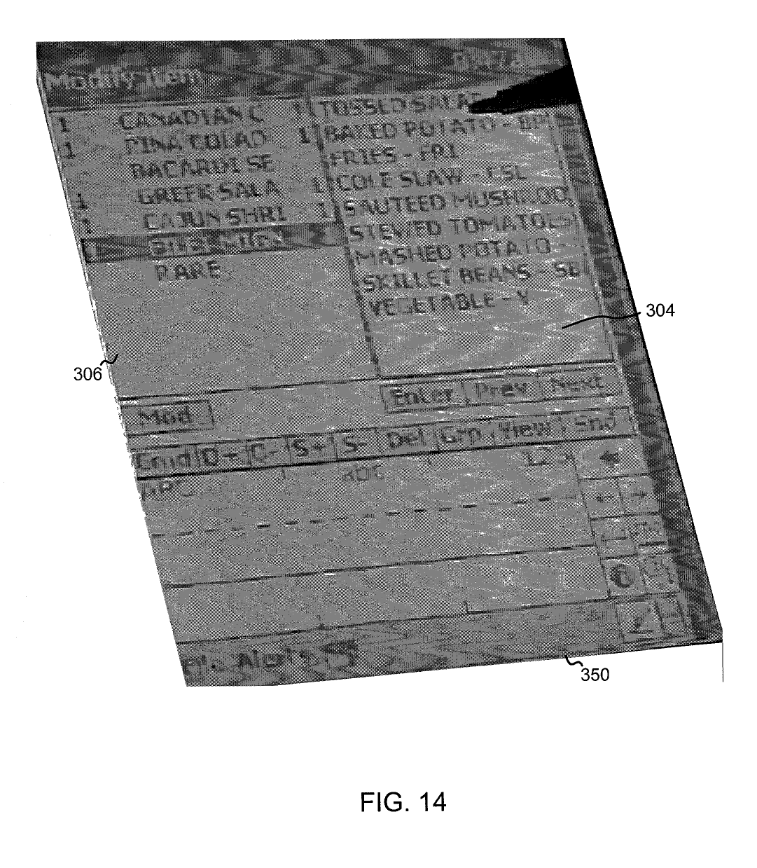

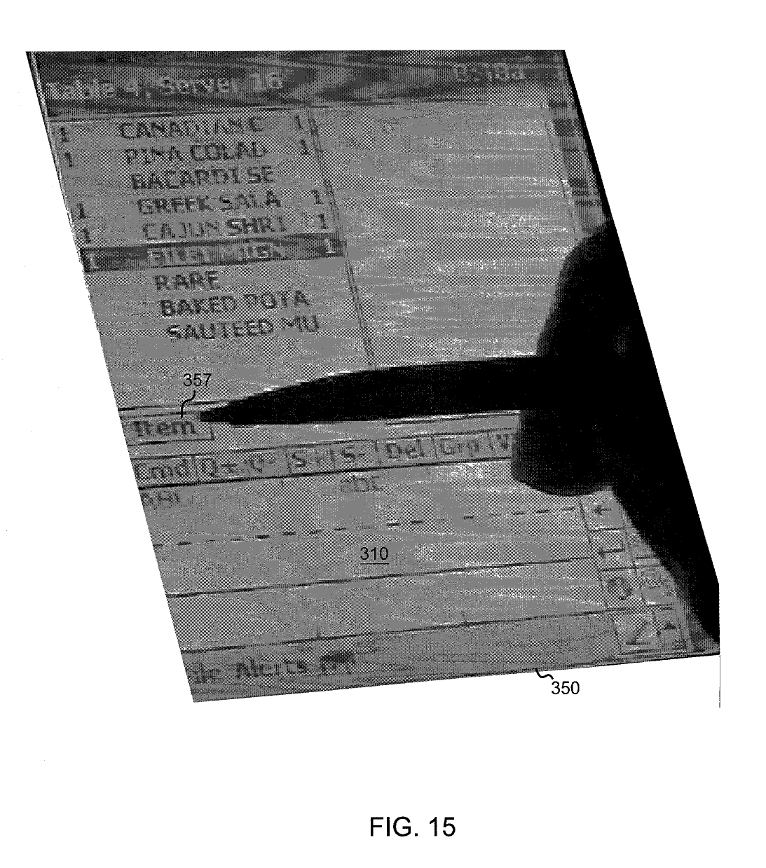

FIG. 14 shows that a rare filet mignon has been entered, by listing the item and modifier in order window 306. But, before allowing the server to enter additional items, handheld computer 400 prompts the server to choose additional forced modifiers associated with the filet mignon. Specifically, handheld computer 400 requires the server to choose two side dishes to accompany the filet mignon. As shown in FIG. 14, handheld computer 400 lists the possible side dishes in selection window 304, including, for example, a tossed salad, a baked potato, fries, cole slaw, sautéed mushrooms, stewed tomatoes, mashed potatoes, skillet beans, and a vegetable. In this example, the server chooses the baked potato and sautéed mushrooms, which are then added to the order in order window 306, as shown in FIG. 15.

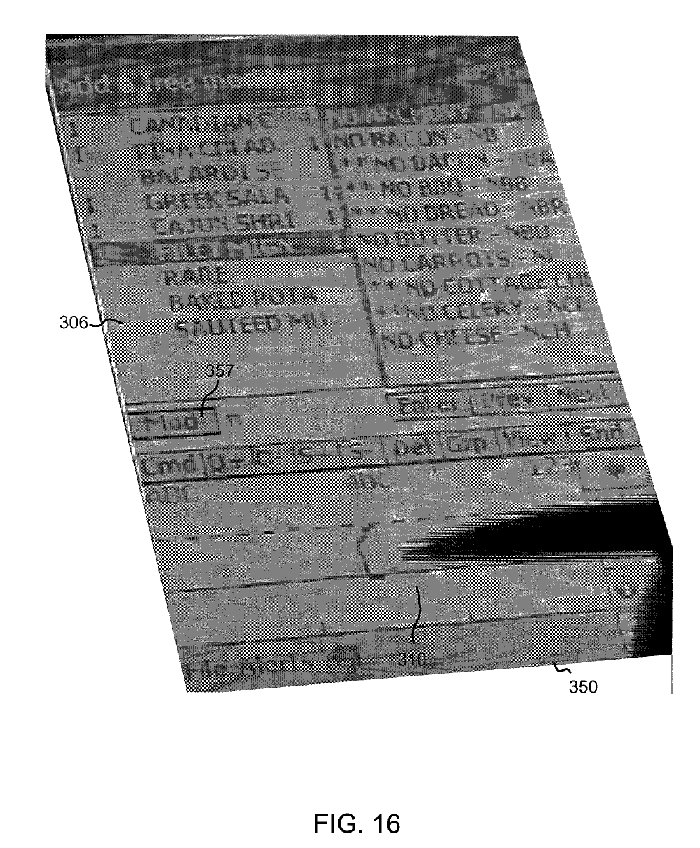

FIG. 15 also shows how a server can modify items at the request of a customer, as opposed to being prompted for forced modifiers. These server- or customer-initiated modifiers are referred to as free modifiers. In this example, the customer's request is that the filet mignon be prepared without onions. As shown, to enter the request, the server touches toggle icon 357 to indicate that a special modifier is being entered, rather than a regular menu item. As shown in FIG. 16, the label on toggle icon 357 changes from “Item” to “Mod”. The server then highlights the item being modified in order window 306 (if it is not already highlighted), and writes the modifier in item/modifier input section 310. As with items, the modifier can be a full word or words, or an abbreviation. In this example, handheld computer 400 recognizes an abbreviation for the modifier. Thus, as shown in FIG. 16, the server enters “no”, which stands for no onions.

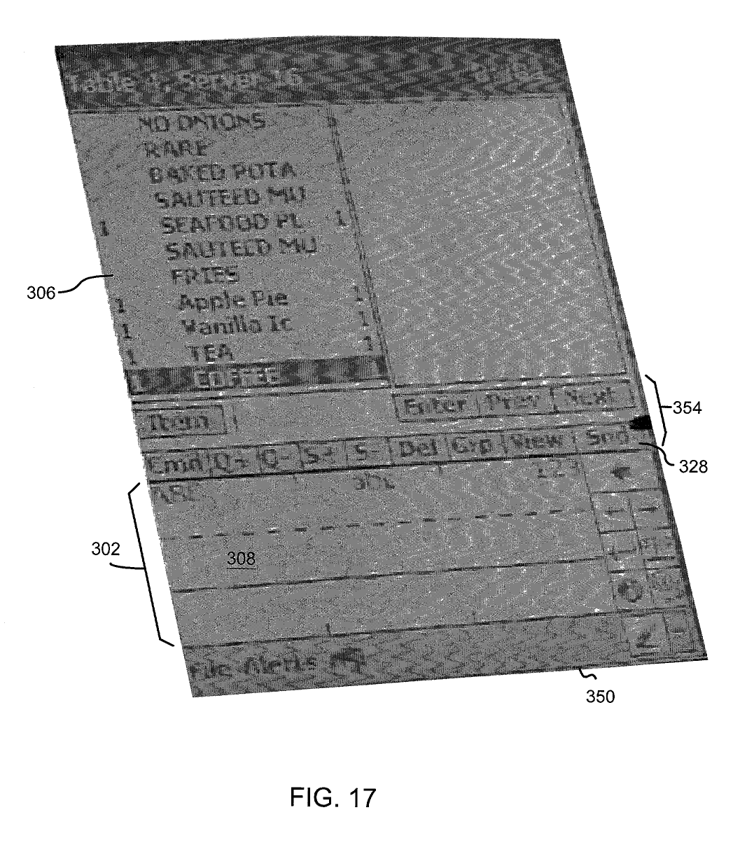

FIG. 17 shows the rest of the order in this example. The server has entered a seafood platter by writing “sp” in item/modifier input section 310. Then, after being prompted for forced modifiers associated with the seafood platter, the server has selected the accompanying side dishes (sautéed mushrooms and fries). Finally, the server enters the items for dessert and coffee, including an “ap” for apple pie, a “vi” for vanilla ice cream, a “t” for tea, and a “co” for coffee. Handheld computer 400 lists each of these items in order window 306.

With the order completely entered, the server is ready to send the order to the kitchen and bar for preparation. To do so, as shown in FIG. 17, the server touches Snd button 328 in speed button area 354. Alternatively, the server could write the send command (e.g., “send” or “s”) in command input section 308 and press confirm button 412. As another alternative, the server could hold confirm button 412 down and write the send command anywhere in input area 302.

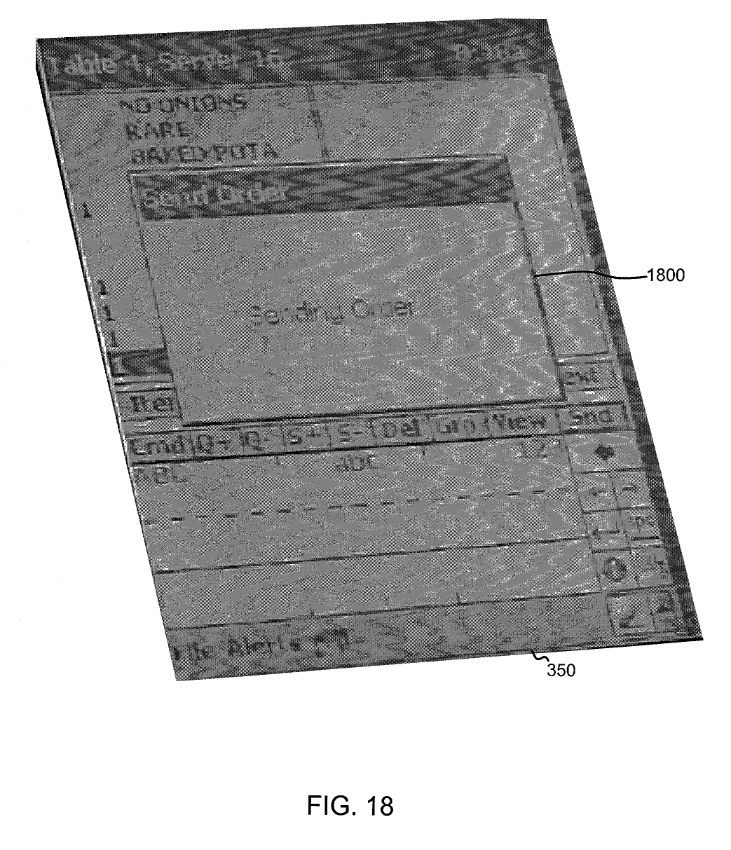

In response to the send command, handheld computer 400 wirelessly communicates the order to a computer network, which displays the order in the appropriate preparation areas (e.g., bar and kitchen). Handheld computer 400 also displays a message 1800 on user interface 350 confirming that the order is being sent, as shown in FIG. 18.

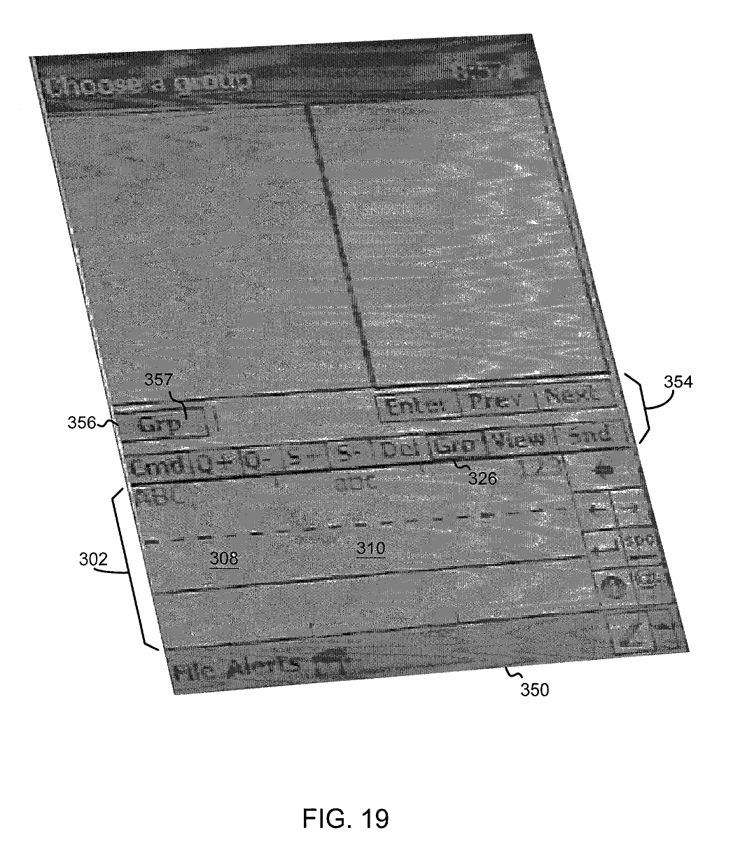

According to a further embodiment, FIGS. 19-30 demonstrate a group function of the present invention, which enables a server to conveniently access a group of menu choices. To initiate this function, a server touches Grp button 326 of speed button area 354 (see FIG. 3C). Alternatively, handheld computer 400 can be configured to initiate the group function based on a command entered in command input section 308 (pressing confirm button 412 afterwards) or entered anywhere in input area 302 (while keeping confirm button 412 pressed).

To provide the group function, handheld computer 400 assigns additional functionality to entry status bar 356 and item/modifier input section 310. Specifically, once the group function is initiated, the label on toggle icon 357 of entry status bar 356 changes to “Grp” to indicate that group characters are being entered. This toggle therefore enables an item, a command, and a group to have the same abbreviation (e.g., “s” could represent a salad item, a send command, and a salad dressing group). As additional functionality, when handheld computer 400 is in the group function mode, item/modifier input section 310 accepts characters corresponding to group words or abbreviations, in the same manner that items and modifiers are recognized.

FIG. 19 illustrates user interface 350 after initiation of the group function. As shown, handheld computer 400 has changed toggle icon 357 to indicate “Grp” and is ready to accept group characters in item/modifier input section 310.

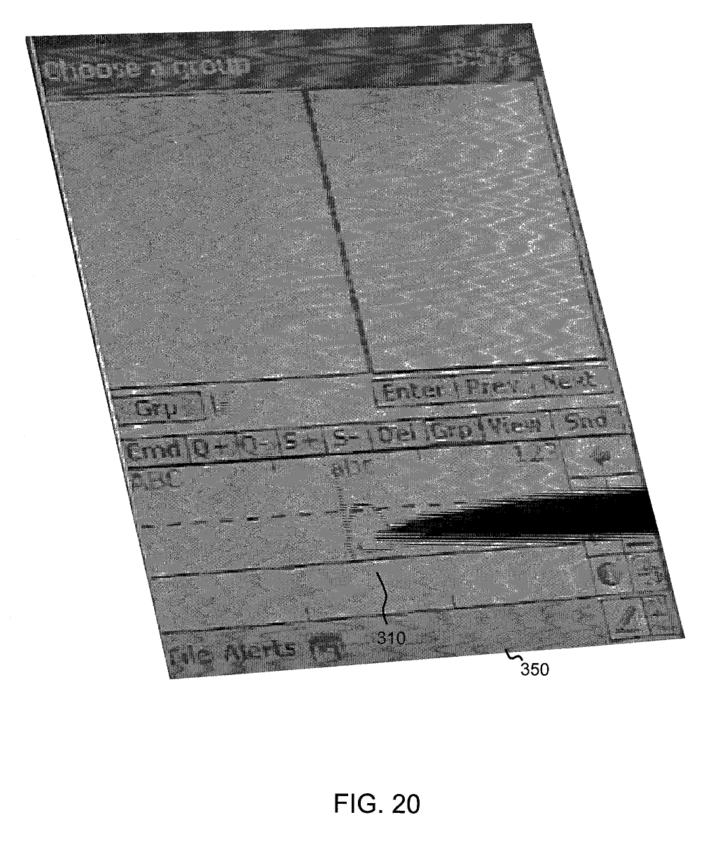

In this example, a customer asks the server what brands of beers the restaurant offers. Rather than memorize the long list of beers, the server uses the group function to lookup the beers. With this function, the server need only remember that beers are listed under a group name starting with the letter “b” for “beer”. Thus, as shown in FIG. 20, the server writes a “b” in item/modifier input section 310.

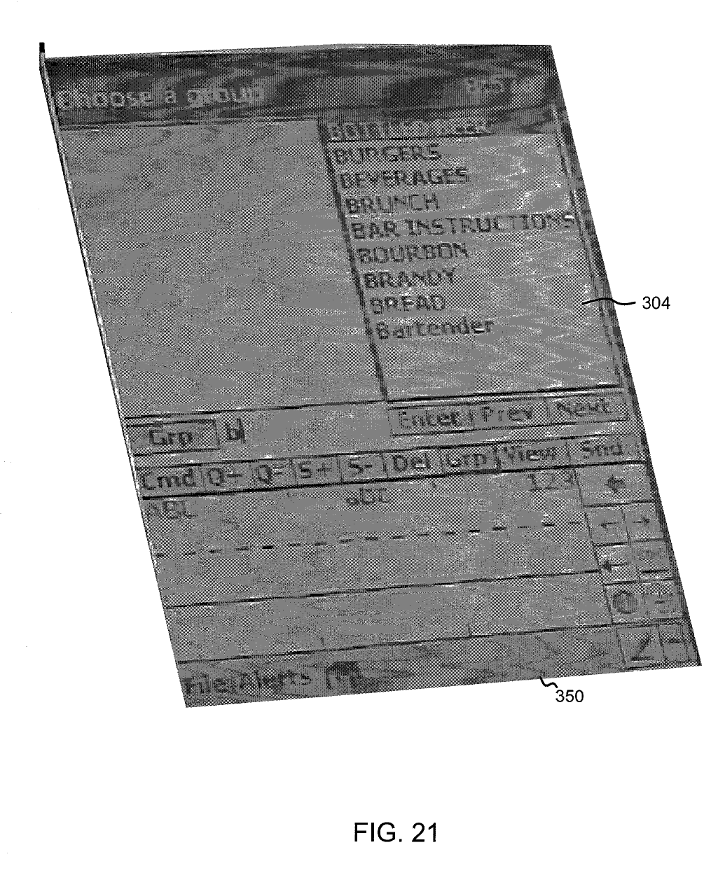

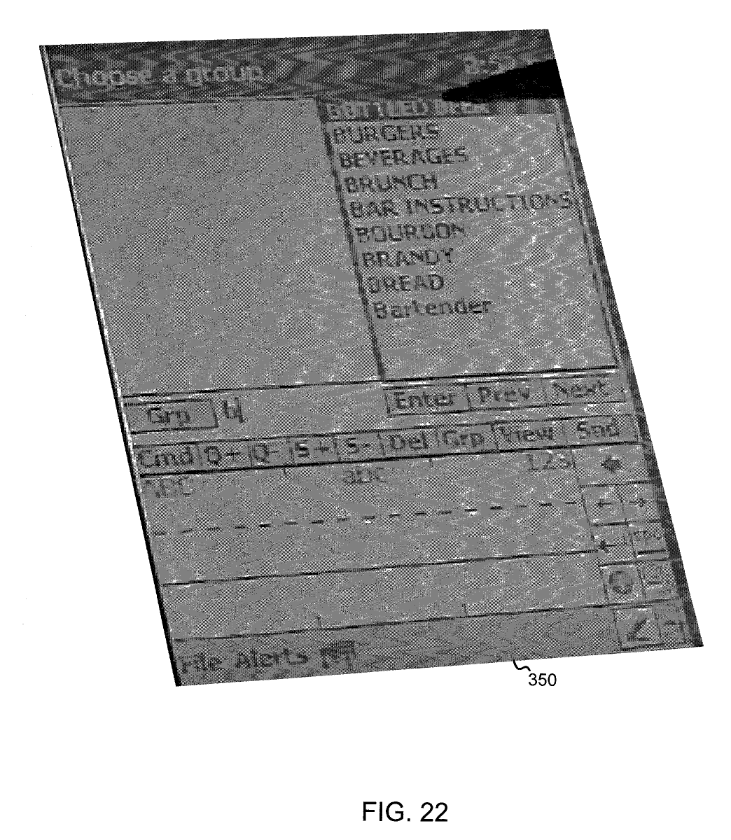

In response, as shown in FIG. 21, handheld computer 400 lists the group names beginning with the letter “b” in selection window 304. At this point, to select a desired group, the server could finish writing the name or abbreviation for the group (e.g., “beer” or “bb”). In this example, however, the server simply touches the name of the group (“bottled beer”) listed in selection window 304, as shown in FIG. 22.

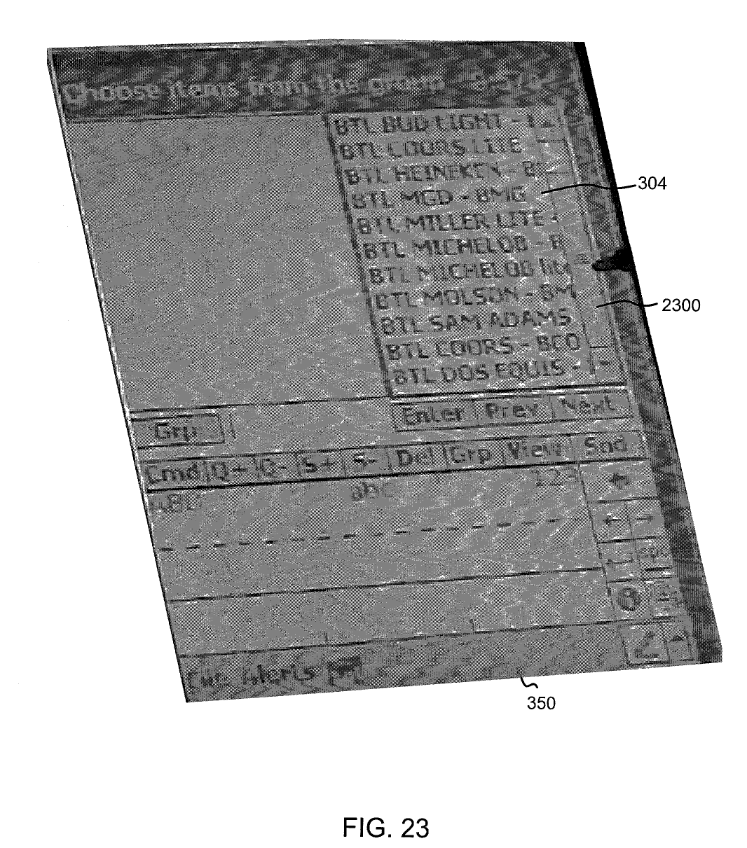

In response to the group selection, as shown in FIG. 23, handheld computer 400 displays in selection window 304 the list of beers that the restaurant offers. If the list cannot fit within selection window 304, then handheld computer 400 provides a scroll bar 2300. The server can use this scroll bar to read through the entire list of beers.

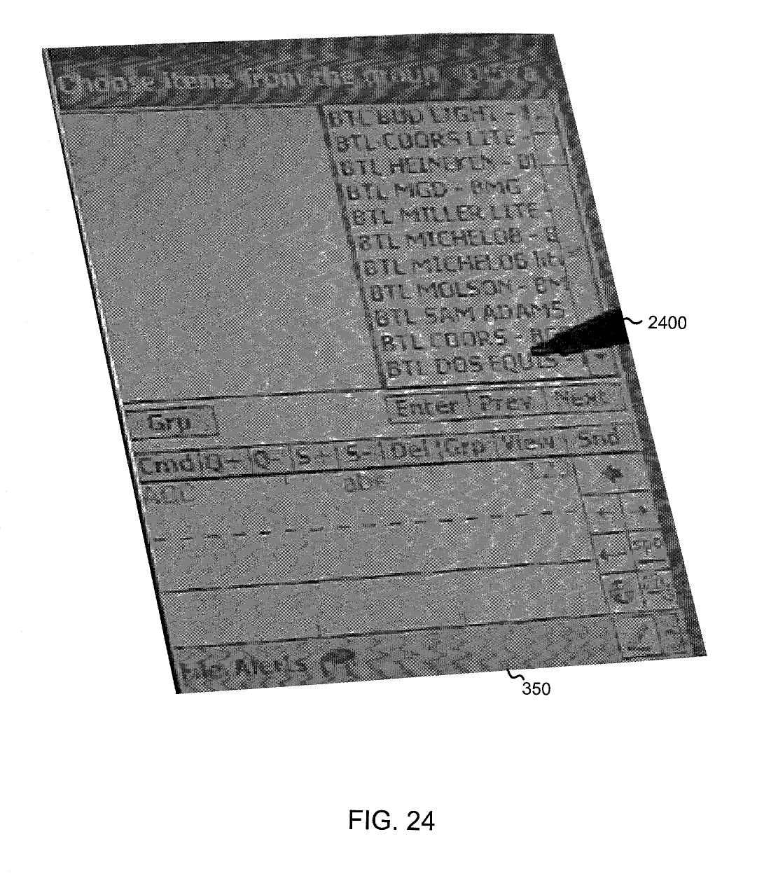

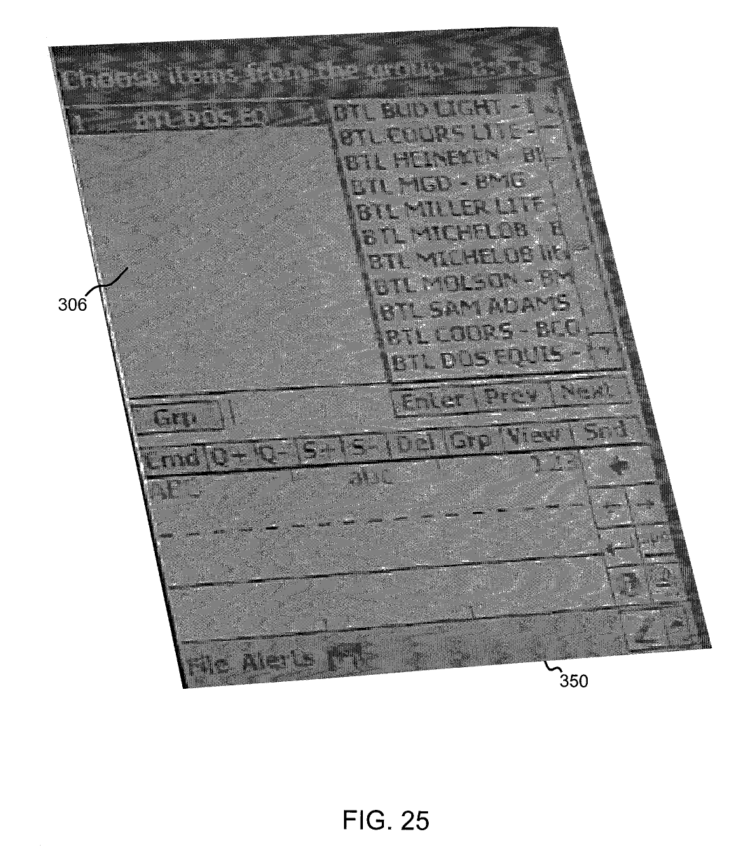

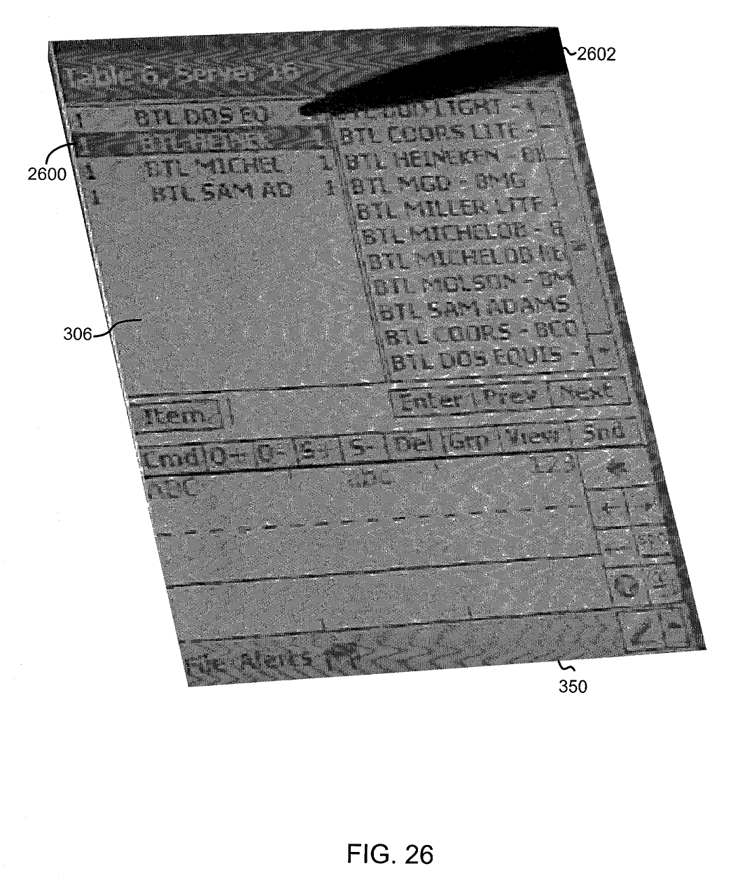

After locating the desired item in selection window 304, the server can select an item from the group. In this case, the server selects a Dos Equis™ beer. FIG. 24 shows the server making the selection by touching the entry for the item with the stylus 2400. In response, handheld computer 400 adds the item to order window 306, as shown in FIG. 25. In this example, the server proceeds to enter three more beers to the order, including a Heineken™, Michelob™, and Sam Adams™, as shown in order window 306 of FIG. 26.

FIG. 26 also illustrates the delete function of an embodiment of the present invention. This delete function may be necessary if, for example, the customer who ordered the Heineken™ changes his mind. The delete function acts on the item that is highlighted in order window 306. Thus, to delete the Heineken™ from the order, the server first touches the corresponding entry in order window 304. FIG. 26 shows the entry 2600 highlighted just after the server has touched it with the stylus 2602.

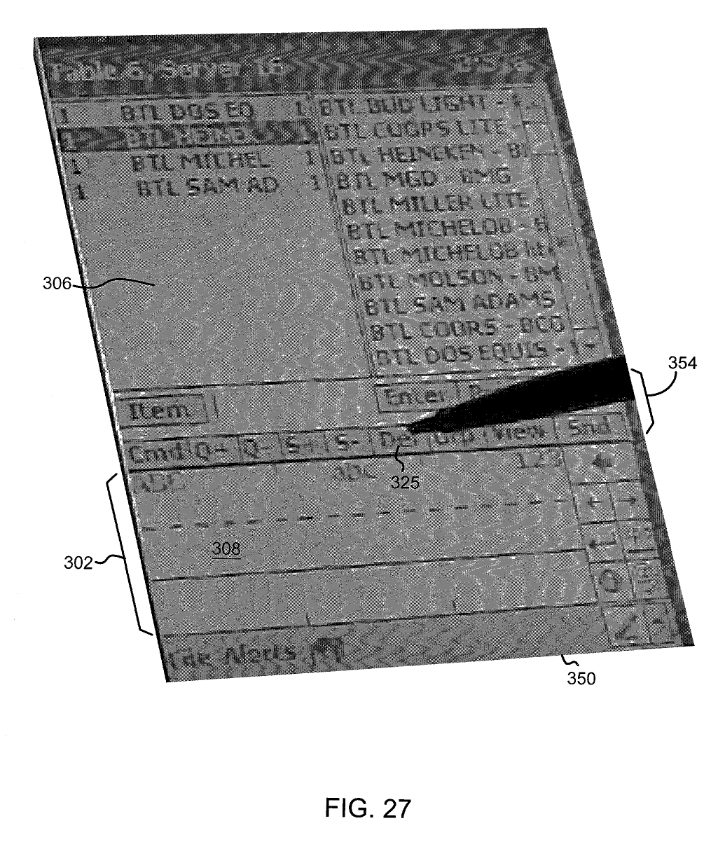

With entry 2600 highlighted, the server then enters the delete command. FIG. 27 shows the server entering this delete command by touching Del button 325 in speed button area 354. Alternatively, the server could enter the command by writing a full word or abbreviation in command input section 308 and pressing confirm button 412. As another alternative, the server could first press confirm button 412 to place handheld computer 400 in a command mode, and then write a full word or abbreviation for the command anywhere in input area 302.

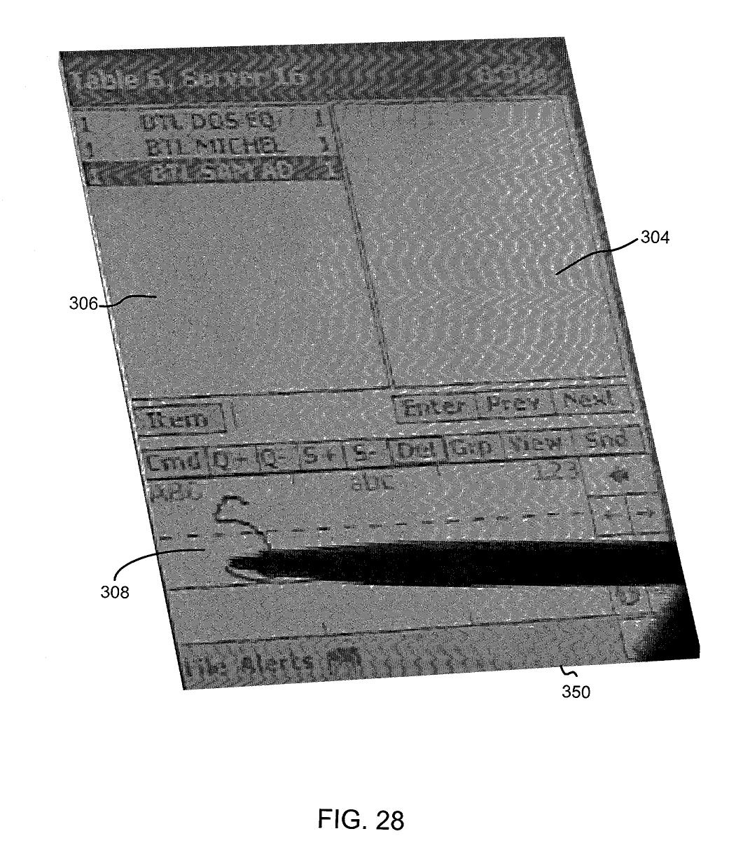

In response to the deletion, handheld computer 400 updates the order shown in order window 306 to remove the Heineken™. FIG. 28 shows this updated order window 306.

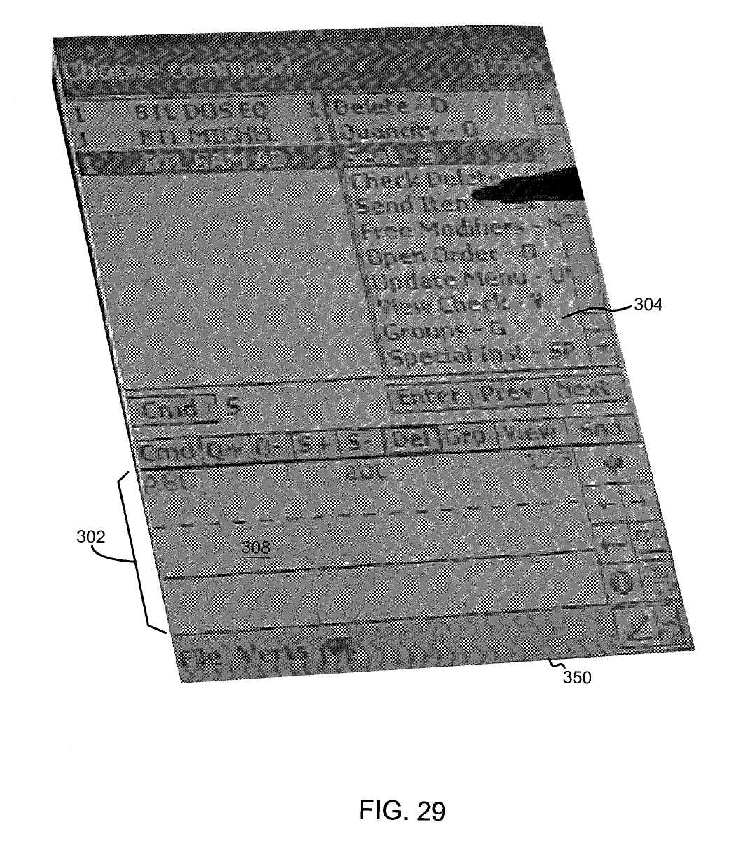

For this example, the order is now complete and the server is ready to send the order for preparation. Therefore, as shown in FIG. 28, the server writes the send command in command input section 308. In this case, the complete abbreviation for the send command is “si”, which stands for “send items”. Thus, the server writes and “s” in command input section 308. The server then selects the appropriate entry in selection window 304, as shown in FIG. 29.

In an alternative embodiment of the present invention, as shown in FIG. 29, handheld computer 400 displays a list of all commands in selection window 304 whenever a character is written in command input section 308. Because there are typically only a few commands, this embodiment of the present invention departs from the abbreviation scheme used for items and modifiers, and lists all possible commands regardless of whether the abbreviations for the commands begin with the letter written in command input section 308. Of course, as described above, the server could avoid the use of selection window 304 altogether by, for example, writing the full abbreviation of the command (e.g., “si”) in command input section 308 and pressing confirm button 412, or by pressing confirm button 412 first to place handheld computer 400 in a command mode and then writing the command (full word or abbreviation) anywhere within input area 302.

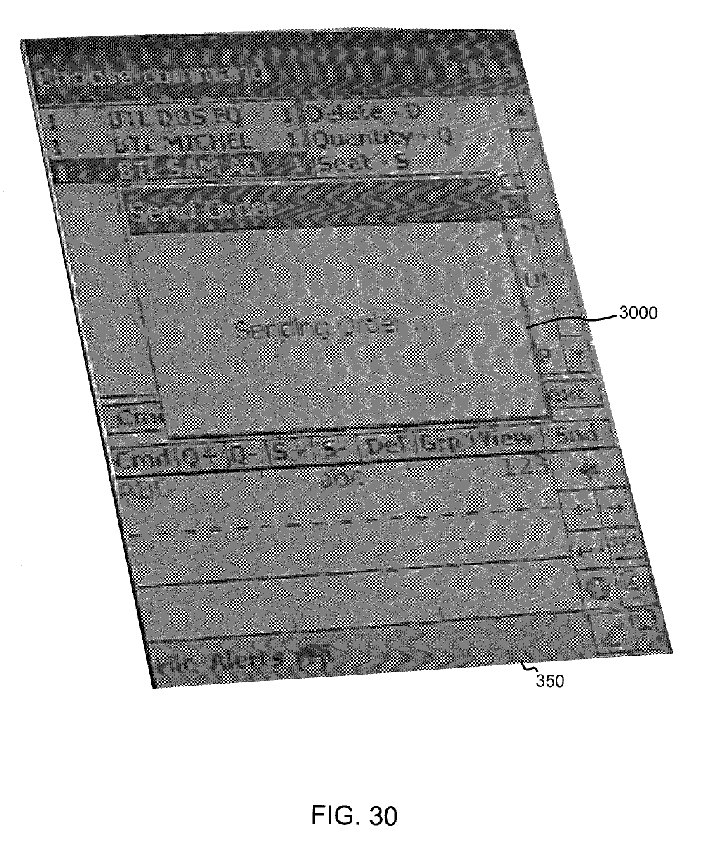

Finally, concluding this example, after the server enters the send command, handheld computer 400 displays a message 3000 on user interface 350 confirming that the order is being sent to the preparation area, as shown in FIG. 30. Handheld computer 400 wirelessly communicates the order to a computer network for display in the preparation area(s).

In a further embodiment of the present invention, handheld computer 400 activates integrated notification device 406 to confirm that an item, modifier, or command has been correctly entered. For example, in the case of an item or modifier, handheld computer 400 could activate integrated notification device 406 when the item or modifier is added to the order in order window 306. Similarly, if a command is correctly entered, handheld computer 400 could activate integrated notification device 406 to indicate that the command is being executed. Preferably, integrated notification device 406 provides inaudible, non-visual feedback (e.g., vibration), which the server inconspicuously senses without disturbing the customers. In this manner, a server can enter data into handheld computer 400 and immediately receive verifications that the data has been correctly entered, all while maintaining eye contact with the customers and not looking down at handheld computer 400.

In a further embodiment of the present invention, handheld computer 400 activates integrated notification device 406 when it is useful or necessary for the server to look at user interface 350. For example, if integrated notification device 406 is a vibrator, handheld computer 400 could activate a short pulse vibrator when a prompt is displayed on user interface 350, such as when the server must select a forced modifier associated with a particular item. Similarly, a long pulse of the integrated notification device 406 could indicate an error condition. With this notification method, handheld computer 400 can signal the server to look down only when necessary, in short intervals, to further maximize the attention paid to customers. For instance, after feeling a short pulse of vibration, the server would quickly look down at selection window 304, choose an entry, and be able to immediately look back up to resume eye contact with the customer.

As an example of this vibration prompt feature, consider an order for a London broil, prepared rare, with a side of baked potato. The server would first enter the London broil by, for example, writing “lb” in item/command input section 310. The server would then press confirm button 412. In response, handheld computer 400 lists the London broil in order window 306. At this point, handheld computer 400 also activates integrated notification device 406, providing a momentary vibration (e.g., 0.2 seconds), to indicate to the server that preparation instructions must be selected from selection window 304. Handheld computer 400 also lists the choices of preparation instructions in selection window 304. The server briefly looks down and touches the “rare” modifier option that appears in selection window 304. Handheld computer 400 then lists the “rare” modifier in order window 306.

Handheld computer 400 then prompts for the next forced modifier, which in this case is a side dish, by again activating integrated notification device 406 to provide a short pulse of vibration. Handheld computer 400 also lists the choices of side dishes in selection window 304. In response, the server briefly looks down and touches the baked potato side dish that appears in selection window 304. Thus, the server can seamlessly transition between long durations of eye contact with the customer and brief glances at handheld computer 400. This vibration feature therefore enables the server to quickly and accurately enter an order, while devoting a majority of his attention to the customer.

Handheld computer 400, with its user interface 350, operates as a part of computer network, according to an embodiment of the present invention. This computer network, which can include both wireless and hardwire components, manages the operation of the restaurant, retail store, or other environment in which the present invention is used. The computer network enables data entry through multiple mobile POS devices. The data entry is consolidated and routed to facilitate the overall operation of the restaurant or other similar establishment.

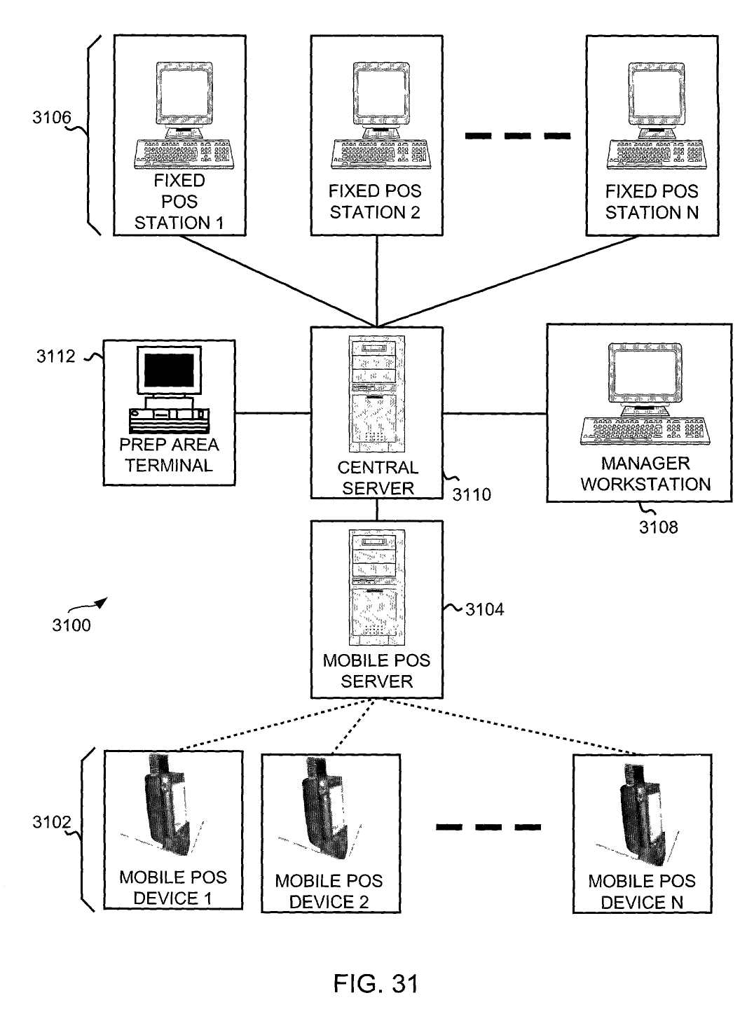

FIG. 31 illustrates an exemplary system architecture of the present invention. As shown, the computer network 3100 includes one or more mobile POS devices 3102, a mobile POS server 3104, one or more fixed POS stations 3106, a manager workstation 3108, a central server 3110, and a preparation area terminal 3112. Although, for illustration purposes, mobile POS server 3104, fixed POS station(s) 3106, manager workstation 3108, and central server 3110 are shown separately, one of ordinary skill in the art would appreciate that these components could be combined into a single component (server or computer) or into multiple components, depending on factors such as the processing and memory capacities of the components, the processing and memory requirements of the installed software, and the number of mobile POS devices and fixed POS stations supported by the computer network.

Central server 3110 runs the network operating system for computer network 3100. Central server 3110 also runs a POS management software (such as Restaurant Manager™, Version 12, produced by Action Systems Inc. of Silver Spring, Md.) and its associated database(s). In an embodiment of the present invention, central server 3110 is a 586, 200 MHz (or better) computer, having 32 Mbytes or more of RAM and 50 Mbytes or more of hard disk space, and provisioned with Windows NT/95™, Windows 2000™, Novell Netware™, or another NETBIOS compatible operating system. As shown in FIG. 31, central server 3110 is a computer in wireline communication with fixed POS station(s) 3106, manager workstation 3108, and mobile POS server 3104, and preparation area terminal 3112. Alternatively, central server 3110 could be in wireless communication with these components.

Manager workstation 3108 is in communication with central server 3110, providing a system administrator with access to management functions of the POS management software provisioned on central server 3110. From manager workstation 3108, the system administrator can configure the operation of fixed POS station(s) 3106 and mobile POS devices 3102. For example, the system administrator can configure the number of fixed stations and mobile devices in communication with central server 3110, can set the access (e.g., passwords) and identifications (e.g., server number) of the users of the system, and can define menu items and modifiers. In an embodiment of the present invention, manager workstation 3108 is a 586, 200 MHz (or better) computer, having 32 Mbytes of RAM and running Windows 95™.

The one or more fixed POS stations 3106 are in communication with central server 3110 and provide users with access to the data entry and retrieval functions of the POS management software. Thus, for example, at the one or more fixed POS stations 3106, users can enter items into an order, send the order to the preparation area, close out the order, and process payment.

The one or more fixed POS stations 3106 could be provisioned with the conventional button menu user interfaces known in the prior art. However, to obtain the same benefits described above for handheld POS devices, and to promote consistency among the user interfaces, an embodiment of the present invention provides the unique user interface described above (with stylus-type data entry capabilities) on the one or more fixed POS stations 3106.

Indeed, although the user interface features provide significant advantages for mobile POS devices, one of ordinary skill in the art would appreciate that these same principles could be applied to a fixed POS station. The user interface of the present invention, and especially the handwriting aspects of the interface, is more efficient than traditional button menu interfaces, whether those traditional interfaces are used on fixed or mobile POS terminals. As one example, the user interface of the present invention makes it easier to retrieve menu items, as opposed to the tedious drill-down buttons of the prior art. Thus, it should be understood that, in addition to mobile handheld POS devices, the present invention applies equally well to fixed POS stations.

Mobile POS server 3104 is in wireline or wireless communication with central server 3110 and wireless communication with mobile POS device(s) 3102. Mobile POS server 3104 is provisioned with communication software that coordinates the user interface and data entry of mobile POS device(s) 3102 with the POS management software and database of central server 3110. As an example, this communication software could include a POS link application that serves POS functions, such as “open table” or “send items”, to central server 3110. The communication software could also include a POS link database table for holding requests and responses to the POS link application. In an embodiment of the present invention, mobile POS server 3104 is provisioned with a Windows 2000™ operating system.

Mobile POS server 3104 also includes one or more wireless access points (WAPS) to facilitate wireless communication with mobile POS device(s) 3102. The wireless access points are located throughout the physical area in which mobile POS device(s) 3102 are used, to ensure that mobile POS server 3104 maintains communication with mobile POS device(s) 3102 at all times. The number and location of the wireless access points depend on factors such as barrier composition and construction and local environmental interference.

The one or more mobile POS devices 3102 are in wireless communication with mobile POS server 3104. As described above, a mobile POS device 3102 is a mobile computer capable of stylus-type data entry and wireless mobile communication, such as the Compaq iPAQ 3600 Series Pocket PC™ with an expansion pack. Each mobile POS device 3102 is provisioned with a software application that, among other possible functions, provides the unique user interface and functions described above, and supports wireless communication with mobile POS server 3104. In an embodiment of the present invention, each mobile POS device 3102 is provisioned with a Windows CE™, Version 3.0 operating system.

Preparation area terminal 3112 is in communication with central server 3110. Terminal 3112 is an output device that relates the orders entered through fixed POS stations 3106 and mobile POS devices 3102. Terminal 3112 could be a stand-alone computer. Alternatively, terminal 3112 could simply be a display monitor connected to central server 3110. As another alternative, preparation area terminal 3112 could be a printer or other similar output device.

Based on the user interface, the handheld computer hardware, and the system architecture described above, the present invention provides the functions necessary to take an order. These functions include one or more of: creating new orders; retrieving orders by table number; adding items; deleting items; modifying items; prompting for and receiving forced modifiers; receiving free modifiers; voiding non-sent orders; entering items by seat number; providing table status; sending orders to preparation areas; adjusting quantities; adjusting seat numbers; printing checks remotely; printing checks locally (using a printer configured in handheld computer 400 or a belt pack 500); settling checks (using a credit card reader configured in handheld computer 400 or a belt pack 500); adding a complimentary item; processing split checks; searching for items by item name or abbreviation; providing an incremental lookup (e.g., a filtering process on a displayed list of items/commands as a user enters the letter defining the items/commands on the list, in which the search string always starts at the beginning of the string being searched—as opposed to “find” functions, which search for the occurrence of the search string anywhere in the strings being searched); displaying items in groups; searching for modifiers; logging on an employee; and logging out an employee.

An alternative embodiment of the present invention provides an additional means of data entry through input area 302 (FIG. 3A). Specifically, a user can activate a keyboard function as an alternative to handwritten input. In this embodiment, handheld computer 400 is configured to initiate this keyboard feature upon receipt of a keyboard command. The keyboard command could be given through a handwritten command (word or abbreviation) in command input section 308 or by touching a dedicated button on user interface 350 (e.g., in speed button area 354). After receiving the command, handheld computer 400 places user interface 350 in a keyboard entry mode, which replaces input area 302 with a keyboard of touch buttons.

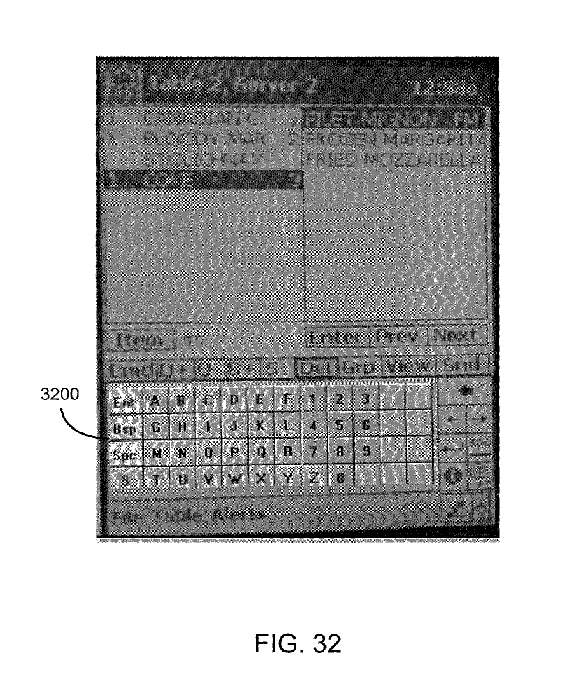

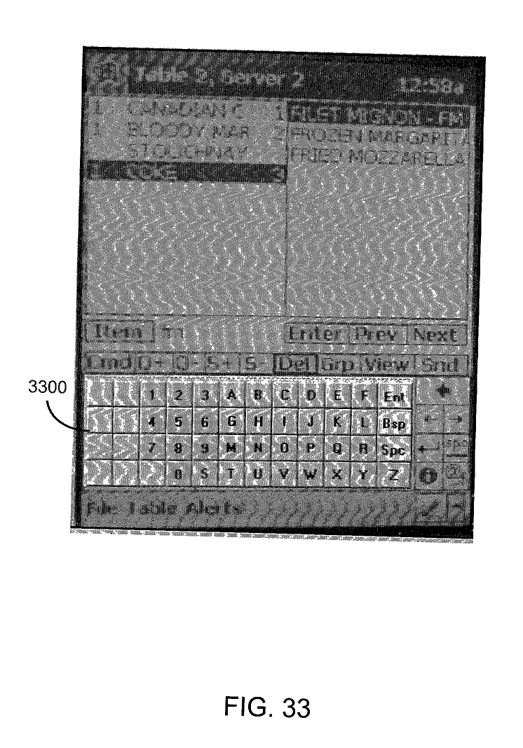

FIGS. 32 and 33 illustrate user interfaces in this keyboard entry mode, which are differently configured to accommodate both right-handed (FIG. 32) and left-handed (FIG. 33) users. As shown, the most used keys are placed on the left for the right-handed keyboard 3200 and the right for the left-handed keyboard 3300, so that the user can tap the keys with minimal hand movement.

This keyboard embodiment recognizes that some users may not want to hand write items and commands, or are unable to master the natural handwriting required for the handwriting input mode.

Although, for illustration purposes, this specification describes the present invention in the context of the foodservice industry, one of ordinary skill in the art would appreciate that the invention is useful for any situation in which a user entering data into a user interface must minimize the time the user looks at the user interface. For example, in addition to receiving orders at a restaurant, the present invention could be used to receive orders at a fast food restaurant, a drive-through line, a stadium, or a nightclub. The present invention could also be used to enter retail sales, to enter scoring while judging an athletic event (e.g., gymnastics or figure skating), or to record answers given by survey participants. The present invention is also useful for any application involving a large number of items that need to be quickly “found” and entered, and for which the use of scanner (e.g., bar code scanner) is precluded. For example, the invention is useful for tracking non-bar coded inventory. For this reason, and notwithstanding the particular benefits associated with using the present invention in a restaurant environment, the system and method described herein should be considered broadly useful for any situation in which a user must quickly locate and enter data into a user interface.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A user interface for receiving an order comprising:
(a) an input area adapted to receive handwritten input indicating an item to add to the order;
(b) a selection window adapted to display items corresponding to the handwritten input; and
(c) an order window adapted to display selected items, as the order.

2. The user interface of claim 1, wherein the input area is further adapted to receive handwritten input indicating a command associated with the order.

3. The user interface of claim 2, wherein the command is one of creating the order, retrieving the order, voiding the order, retrieving a status of the order, sending the order to a preparation area, adjusting quantities associated with the order, adjusting seat numbers associated with the order, printing a check remotely for the order, printing a check locally for the order, settling a check for the order, adding a complimentary item to the order, processing a split check for the order, searching for items, providing an incremental lookup, displaying items in groups, searching for modifiers, logging on an employee, and logging out an employee.

4. The user interface of claim 1, wherein the input area is further adapted to receive handwritten numeric input associated with the order.

5. The user interface of claim 1, wherein the input area is further adapted to receive a selection of the item, wherein the selection is a handwritten character.

6. The user interface of claim 1, wherein the selection window is further adapted to receive a selection of an item from the displayed items, wherein the selection is a touch of the item listed in the displayed items.

7. The user interface of claim 1, wherein the input area is adapted to recognize an abbreviation of the item as the handwritten input.

8. The user interface of claim 1, further comprising an entry status bar that displays characters that are entered in the input area, as the characters are being entered.

9. The user interface of claim 1, further comprising a button that executes a command associated with the order.

10. The user interface of claim 1, wherein the input area is further adapted to receive keyboard input as an alternative to the handwritten input.

11. The user interface of claim 1, wherein the input area is further adapted to receive a second handwritten input indicating a modifier associated with a selected item,
wherein the selection window is further adapted to display modifiers corresponding to the second handwritten input, and
wherein the order window is further adapted to display selected modifiers in the order.

12. The user interface of claim 11, wherein the selection window is further adapted to receive a selection of a modifier from the displayed modifiers, wherein the selection is a touch of the modifier listed in the displayed modifiers.

13. The user interface of claim 111, wherein the input area is adapted to recognize an abbreviation of the modifier as the second handwritten input.

14. The user interface of claim 111, wherein the user interface further comprises a toggle button adapted to configure the input area to receive a handwritten input as one of an item and a modifier.

15. The user interface of claim 11, wherein the user interface is adapted to require a user to choose a modifier after the user interface receives a selected item.

16. An apparatus for recording an order comprising:
(a) a computer provisioned with a user interface, the user interface comprising
an input area adapted to receive handwritten input indicating an item to add to the order,
a selection window adapted to display a list of items corresponding to the handwritten input, including a highlighted entry in the list, and
an order window adapted to display items selected to be added to the order; and
(b) a button in communication with the computer, wherein the button is adapted to send a signal to the computer when the button is pressed, and wherein the signal indicates a selection of the highlighted entry.

17. The apparatus of claim 16, wherein the handwritten input is an abbreviation for an item, and wherein the highlighted item corresponds to the abbreviation.

18. The apparatus of claim 16, wherein the button is adapted to send a second signal to the computer when the button is held down, and wherein the second signal causes the computer to accept handwritten input in the input area as a command associated with the order.

19. The apparatus of claim 16, further comprising a wireless card in communication with the computer, wherein the wireless card enables the computer to wirelessly communicate with a computer network.

20. The apparatus of claim 16, further comprising a notification device in communication with the computer, wherein the notification device provides a non-visual alert for at least one of an error condition and a prompt for input of a modifier associated with a selected item.

21. The apparatus of claim 20, wherein the notification device is one of a vibrator and a speaker.

22. The apparatus of claim 16, further comprising a tether adapted to connect the computer to a user of the apparatus.

23. The apparatus of claim 22, further comprising a belt pack attached to the tether, wherein the belt pack is adapted to be worn by the user.

24. The apparatus of claim 23, wherein the belt pack includes a battery in communication with the computer.

25. The apparatus of claim 23, wherein the belt pack includes a notification device in communication with the computer.

26. The apparatus of claim 23, wherein the belt pack includes a credit card reader in communication with the computer.

27. The apparatus of claim 23, wherein the belt pack includes a printer in communication with the computer.

28. The apparatus of claim 23, wherein the tether contains cables connecting the computer to at least one of a battery, a notification device, a credit card reader, and a printer, in the belt pack.

29. The apparatus of claim 16, further comprising at least one of a credit card reader and a printer in communication with the computer.

30. The apparatus of claim 16, wherein the input area comprises a command input section, an item input section, and a numeric input section,
wherein the command input section is adapted to receive characters of commands,
wherein the item input section is adapted to receive characters of items, and
wherein the numeric input section is adapted to receive numeric characters.

31. The apparatus of claim 30, wherein the item input section is further adapted to receive characters identifying groups of items.

32. The apparatus of claim 30, wherein the command input section is adapted to receive lowercase cursive characters and to return uppercase characters, and wherein the item input section is adapted to receive lowercase cursive characters and to return lowercase characters.

33. The apparatus of claim 16, wherein the input area is further adapted to receive a second handwritten input indicating a modifier associated with a selected item,
wherein the selection window is further adapted to display a second list of modifiers corresponding to the second handwritten input, including a highlighted entry of the second list, and
wherein the order window is further adapted to display selected modifiers in the order.

34. A system for facilitating point-of-sale (POS) transactions comprising:
(a) one or more mobile POS devices, wherein at least one of the mobile POS devices is provisioned with a user interface, the user interface comprising
an input area adapted to receive handwritten input indicating an item to add to the order,
a selection window adapted to display items corresponding to the handwritten input, and
an order window adapted to display, as the order, selected items;
(b) a POS server in wireless communication with the one or more mobile POS devices; and
(c) a central server in communication with the POS server.

35. The system of claim 34, wherein the at least one mobile POS device is adapted to transmit the order through the POS server and to the central server.

36. The system of claim 34, wherein the one or more mobile POS devices are adapted to transmit the order for output at a preparation area terminal.

37. The system of claim 34, further comprising:
(d) a manager workstation in communication with the central server;
(e) one or more fixed POS stations in communication with the central server; and
(f) a preparation area terminal in communication with the central server.

38. The system of claim 37, wherein at least one of the one or more fixed POS stations is provisioned with the user interface.

39. The system of claim 35, wherein the input area is further adapted to receive a handwritten input indicating a command to send the order for preparation,
wherein, in response to the command, a mobile POS device of the at least one of the mobile POS devices transmits the order through the POS server and to the central server, and
wherein the central server transmits the order to the preparation area terminal for output to a user.

40. The system of claim 35, wherein the input area is further adapted to receive a second handwritten input indicating a modifier associated with a selected item,
wherein the selection window is further adapted to display modifiers corresponding to the second handwritten input, and
wherein the order window is further adapted to display selected modifiers in the order.

41. A method for receiving an order of an item through a POS computer comprising the steps of
receiving a handwritten input from a user on a user interface of the POS computer, wherein the handwritten input identifies the item;
receiving an indication from the user through the POS computer, wherein the indication selects the item; and
adding the item to the order.

42. The method of claim 41, wherein the indication comprises one of a depressed button on the POS computer and a second handwritten input on the user interface of the POS computer.

43. The method of claim 41, further comprising the step of displaying a list of possible items corresponding to the handwritten input, and wherein the indication comprises touching the item in the list.

44. The method of claim 41, wherein the step of receiving the handwritten input comprises recognizing an abbreviation for the item.

45. The method of claim 41, further comprising the steps of:
receiving a second handwritten input from the user identifying a modifier associated with the item;
receiving a second indication from the user, wherein the second indication selects the modifier; and
adding the modifier to the order.

46. The method of claim 41, further comprising the steps of:
prompting the user for a modifier associated with the item;
receiving a selected modifier from the user; and
adding the selected modifier to the order.

47. The method of claim 46, wherein the step of prompting comprises providing the user with non-visual feedback.

48. The method of claim 41, further comprising the step of alerting the user to an error condition by providing non-visual feedback.

49. The method of claim 41, further comprising the steps of:
displaying the order on the POS computer;
receiving a command to send the order for preparation; and
sending the order to an output device in a preparation area.

50. The method of claim 41, wherein the step of receiving the command to the send the order comprises receiving a second handwritten input from the user on the user interface of the POS computer.

51. The method of claim 41, wherein the POS computer has a button, and wherein the step of receiving the command to send the order comprises receiving a push of the button concurrent with a second handwritten input from the user on the user interface of the POS computer.

52. A method for receiving an order of a customer through a user interface of a mobile POS computer, the user interface comprising an input area, a selection window, and an order window, the method comprising the steps of:
receiving handwritten input through the input area;
displaying a list of items in the selection window that correspond to the handwritten input;
receiving a selection of an item to add to the order, wherein the selection is one of a second handwritten input in the input area and a touch of an entry listed in the selection window; and
displaying the selected item in the order window as the order.

53. The method of claim 52, further comprising the steps of:
transmitting the order from the mobile POS computer to a server; and
transmitting the order from the server to an output device in a preparation area.

54. The method of claim 52, wherein the mobile POS computer has a button and wherein the method further comprises the step of displaying a highlighted item in the selection window, and
wherein the selection is one of the second handwritten input in the input area, the touch of an entry listed in the selection window, and a press of the button, and
wherein, if the selection is the press of the button, then the selected item is the highlighted item.

55. The method of claim 52, wherein the handwritten input is a character and the items in the list have abbreviations beginning with the character.

56. The method of claim 52, further comprising the steps of:
displaying a prompt to choose a modifier associated with the selected item;
displaying a list of modifiers in the selection window that correspond to the selected item;
receiving a selection of a modifier to add to the order, wherein the selection is one of a third handwritten input in the input area and a touch of a modifier entry listed in the selection window; and
displaying the selected modifier in the order window as part of the order.

57. The method of claim 56, wherein the mobile POS computer has a button and wherein the method further comprises the step of displaying a highlighted modifier in the selection window, and
wherein the selection of the modifier is one of the third handwritten input in the input area, the touch of an entry listed in the selection window, and a press of the button, and
wherein, if the selection is the press of the button, then the selected modifier is the highlighted modifier.

58. A user interface for receiving an order comprising:
(a) an input area adapted to receive handwritten input indicating an item to add to the order;
(b) a selection window adapted to display items corresponding to the handwritten input;
(c) an order window adapted to display selected items, as the order,
wherein the input area comprises a command input section, an item input section, and a numeric input section,
wherein the command input section is adapted to receive characters of commands,
wherein the item input section is adapted to receive characters of items, and
wherein the numeric input section is adapted to receive numeric characters.

59. The user interface of claim 58, wherein the item input section is capable of receiving characters identifying groups of items.

60. The user interface of claim 58, wherein the command input section is adapted to receive lowercase cursive characters and to return uppercase characters, and wherein the item input section is adapted to receive lowercase cursive characters and to return lowercase characters.

61. A user interface for receiving an order comprising:
(a) an input area adapted to receive a handwritten input corresponding to one of an item, a modifier, and a command, wherein the handwritten input is an abbreviation having one or more characters; and
(b) a selection window adapted to display selections of the one of an item, a modifier, and a command, wherein the selections have abbreviations beginning with the one or more characters received through the input area, and wherein the selection window is further adapted to receive a choice of the selections from a user.

62. The user interface of claim 61, wherein the selection window is further adapted to highlight a selection that has an abbreviation matching the one or more characters received through the input area.

63. The user interface of claim 61, wherein the choice comprises a touch of a selection listed in the selection window.

64. The user interface of claim 62, wherein the choice comprises a signal received from a button in communication with the user interface, and wherein the choice is the selection that is highlighted in the selection window.
